(19) United States
(12) Patent Application Publication
(10) Pub. No.: US 2017/0248889 A1
(43) Pub. Date: Aug. 31, 2017

(54) IMAGE DENSITY DETECTOR, IMAGE FORMING APPARATUS INCORPORATING IMAGE DENSITY DETECTOR, IMAGE DENSITY DETECTING METHOD, AND IMAGE FORMING METHOD

(71) Applicants: Yuuichiroh Uematsu, Kanagawa (JP); Natsumi Matsue, Kanagawa (JP); Akira Yoshida, Tokyo (JP); Akio Kosuge, Kanagawa (JP); Keiko Matsumoto, Kanagawa (JP)

(72) Inventors: Yuuichiroh Uematsu, Kanagawa (JP); Natsumi Matsue, Kanagawa (JP); Akira Yoshida, Tokyo (JP); Akio Kosuge, Kanagawa (JP); Keiko Matsumoto, Kanagawa (JP)

(73) Assignee: Ricoh Company, Ltd., Tokyo (JP)

(21) Appl. No.: 15/436,598

(22) Filed: Feb. 17, 2017

(30) Foreign Application Priority Data
Feb. 25, 2016 (JP) 2016034815

(51) Int. Cl. G03G 15/00

(52) U.S. Cl. CPC G03G 15/5062

(57) ABSTRACT

An image density detector for detecting image density of an image borne by an image bearer includes a reference board, a light emitter, a light receiver, an image density calculator, and an image density detecting condition corrector. The reference board has a spectral reflectance distribution closer to a spectral reflectance distribution of the image forming material than a spectral reflectance distribution of white. The light emitter emits light to the reference board and the image borne by the image bearer. The light receiver receives the light reflected from the image and the reference board. The image density calculator calculates the image density of the image based on an output of the light receiver receiving the light reflected from the image. The image density detecting condition corrector corrects an image density detecting condition based on an output of the light receiver receiving the light reflected from the reference board.

### CROSS-REFERENCE TO RELATED APPLICATION

This patent application is based on and claims priority pursuant to 35 U.S.C. §119(a) to Japanese Patent Application No. 2016-034815, filed on Feb. 25, 2016, in the Japan Patent Office, the entire disclosure of which is hereby incorporated by reference herein.

### BACKGROUND

Technical Field

Embodiments of the present disclosure generally relate to an image density detector, an image forming apparatus, an image density detecting method, and an image forming method, and more particularly, to an image density detector for detecting image density, an image forming apparatus for forming an image on a recording medium and incorporating the image density detector, a method for detecting image density, and a method for forming an image on a recording medium.

Related Art

Various types of electrophotographic image forming apparatuses are known, including copiers, printers, facsimile machines, and multifunction machines having two or more of copying, printing, scanning, facsimile, plotter, and other capabilities. Such image forming apparatuses usually form an image on a recording medium according to image data. Specifically, in such image forming apparatuses, for example, a charger uniformly charges a surface of a photoconductor as an image bearer. An optical writer irradiates the surface of the photoconductor thus charged with a light beam to form an electrostatic latent image on the surface of the photoconductor according to the image data. A developing device supplies toner to the electrostatic latent image thus formed to render the electrostatic latent image visible as a toner image. The toner image is then transferred onto a recording medium either directly, or indirectly via an intermediate transfer belt. Finally, a fixing device applies heat and pressure to the recording medium bearing the toner image to fix the toner image on the recording medium. Thus, the image is formed on the recording medium.

Such image forming apparatuses typically include an optical sensor to detect image density of a test toner image, which is formed on the surface of an image bearer, such as a toner image bearer and a recording medium, for density detection. The image forming apparatuses then determine the appropriate image forming conditions to be used in image formation based on the image density detected by the optical sensor.

### SUMMARY

In one embodiment of the present disclosure, a novel image density detector for detecting image density of an image borne by an image bearer is described. The image density detector includes a reference board, a light emitter, a light receiver, an image density calculator, and an image density detecting condition corrector. The reference board has a spectral reflectance distribution closer to a spectral reflectance distribution of the image forming material than a spectral reflectance distribution of white. The light emitter emits light to the reference board and the image borne by the image bearer. The light receiver receives the light emitted by the light emitter and reflected from the image and the reference board. The image density calculator calculates the image density of the image based on an output of the light receiver receiving the light emitted by the light emitter and reflected from the image. The image density detecting condition corrector corrects an image density detecting condition based on an output of the light receiver receiving the light emitted by the light emitter and reflected from the reference board.

Also described is a novel image forming apparatus incorporating the image density detector described above.

Also described is a novel method for detecting image density. The method includes: emitting light to an image on a surface of an image bearer; detecting image density of the image based on the light emitted to and reflected from the image; emitting light to a reference board having a predetermined spectral reflectance distribution; and correcting an image density detecting condition based on the light emitted to and reflected from the reference board. The predetermined spectral reflectance distribution of the reference board is closer to a spectral reflectance distribution of an image forming material with which the image is formed than a spectral reflectance distribution of white.

Also described is a novel method for forming an image on a recording medium. The method includes: forming a first image for density detection on a surface of an image bearer; detecting image density of the first image according to the method described above; adjusting one or more image forming conditions based on the image density thus detected; and forming a second image under the one or more image forming conditions thus adjusted.

### BRIEF DESCRIPTION OF THE DRAWINGS

A more complete appreciation of the disclosure and many of the attendant advantages thereof will be more readily obtained as the same becomes better understood by reference to the following detailed description of embodiments when considered in connection with the accompanying drawings, wherein:

FIG. 1 is a schematic view of an image forming apparatus according to an embodiment of the present disclosure;

FIG. 2 is a schematic view of an image forming station incorporated in the image forming apparatus of FIG. 1;

FIG. 3 is a block diagram illustrating a functional structure of a controller incorporated in the image forming apparatus of FIG. 1;

FIG. 4 is a cross-sectional side view of a density sensor incorporated in the image forming apparatus of FIG. 1;

FIG. 5 is a plan view of a line sensor, a reference board mounted on a shutter, and a test toner image formed on an intermediate transfer belt incorporated in the image forming apparatus of FIG. 1, illustrating relative positions thereof;

FIG. 6 is a perspective view of the density sensor and the intermediate transfer belt;

FIG. 7 is a graph illustrating an example of spectral distributions of red, green, and blue light emitted by red, green, and blue light emitting diodes, respectively;

FIG. 8 is a graph illustrating an example of a spectral sensitivity distribution of one of image sensors incorporated in the line sensor;

FIG. 9 is a graph illustrating an example of spectral reflectance distributions of cyan, yellow, and magenta toner images;

FIG. 10 is a flowchart of a comparative process of calculating an amount of toner contained in a toner image by use of a white reference board;

FIG. 11A is a graph illustrating a relationship between output data of the image sensors and position of the image sensors in a main scanning direction for a comparative shading correction;

FIG. 11B is a graph illustrating a relationship between corrected output data of the image sensors and the position of the image sensors in the main scanning direction;

FIG. 12 is a graph illustrating an example of a spectral reflectance distribution of the white reference board;

FIG. 13A is a graph illustrating the spectral reflectance distribution of the cyan toner image and the spectral distribution of the blue light;

FIG. 13B is a graph illustrating the spectral reflectance distribution of the white reference board and the spectral distribution of the blue light;

FIG. 14A is a graph illustrating the spectral reflectance distribution of the magenta toner image and the spectral distribution of the red light;

FIG. 14B is a graph illustrating the spectral reflectance distribution of the yellow toner image and the spectral distribution of the red light;

FIG. 14C is a graph illustrating the spectral reflectance distribution of the white reference board and the spectral distribution of the red light;

FIG. 15A is a graph illustrating a relationship between the output data of the image sensors and the position of the image sensors in the main scanning direction for another comparative shading correction;

FIG. 15B is a graph illustrating a relationship between corrected output data of the image sensors and the position of the image sensors in the main scanning direction;

FIG. 16 is a graph illustrating an example of a spectral distribution of a light emitting diode incorporated in a comparative light source that emits white light;

FIG. 17 is a graph illustrating an example of spectral sensitivity distributions of comparative image sensors provided with red, green, and blue filters, respectively;

FIG. 18 is a graph illustrating an example of the spectral reflectance distributions of the cyan, yellow, and magenta toner images and spectral reflectance distributions of cyan, yellow, and magenta reference boards;

FIG. 19 is a flowchart of a process of calculating an amount of toner contained in the cyan toner image;

FIG. 20A is a graph illustrating a relationship between the output data of the image sensors and the position of the image sensors in the main scanning direction for a shading correction by use of the cyan reference board;

FIG. 20B is a graph illustrating a relationship between corrected output data of the image sensors and the position of the image sensors in the main scanning direction;

FIG. 21 is a plan view of the line sensor, the reference board mounted on the shutter, and a gradation pattern toner image formed on the intermediate transfer belt, illustrating relative positions thereof;

FIG. 22 is a plan view of the line sensor, a variation of the reference board mounted on the shutter, and a variation of the test toner image formed on the intermediate transfer belt, illustrating relative positions thereof;

FIG. 23 is a flowchart of a process of identifying contamination in the density sensor;

FIG. 24 is a schematic view of a cleaning mechanism in the density sensor;

FIG. 25 is a graph illustrating a relationship between detection error of toner amount and temperature;

FIG. 26 is a flowchart of a process of calculating an amount of toner contained in the test toner image according to a first example;

FIG. 27 is a graph illustrating a relationship between the detection error of toner amount and the temperature in the first example;

FIG. 28 is a graph illustrating a relationship between the detection error of toner amount and the temperature when the white reference board is used;

FIG. 29 is a flowchart of the process of calculating an amount of toner contained in the test toner image according to a second example;

FIG. 30 is a graph illustrating a relationship between the detection error of toner amount and the temperature in the second example;

FIG. 31 is a graph illustrating a distribution of reflectance difference of the magenta toner image and the spectral distribution of the red light; and

FIG. 32 is a flowchart of the process of FIG. 26 combined with an output adjustment process.

The accompanying drawings are intended to depict embodiments of the present disclosure and should not be interpreted to limit the scope thereof. Also, identical or similar reference numerals designate identical or similar components throughout the several views.

### DETAILED DESCRIPTION

In describing embodiments illustrated in the drawings, specific terminology is employed for the sake of clarity. However, the disclosure of this patent specification is not intended to be limited to the specific terminology so selected and it is to be understood that each specific element includes all technical equivalents that have the same function, operate in a similar manner, and achieve similar results.

Although the embodiments are described with technical limitations with reference to the attached drawings, such description is not intended to limit the scope of the disclosure and not all of the components or elements described in the embodiments of the present disclosure are indispensable to the present disclosure.

In a later-described comparative example, embodiment, and exemplary variation, for the sake of simplicity like reference numerals are given to identical or corresponding constituent elements such as parts and materials having the same functions, and redundant descriptions thereof are omitted unless otherwise required.

As used herein, the singular forms “a”, “an”, and “the” are intended to include the plural forms as well, unless the context clearly indicates otherwise.

It is to be noted that, in the following description, suffixes Y, C, M, and K denote colors yellow, cyan, magenta, and black, respectively. To simplify the description, these suffixes are omitted unless necessary.

Referring now to the drawings, embodiments of the present disclosure are described below.

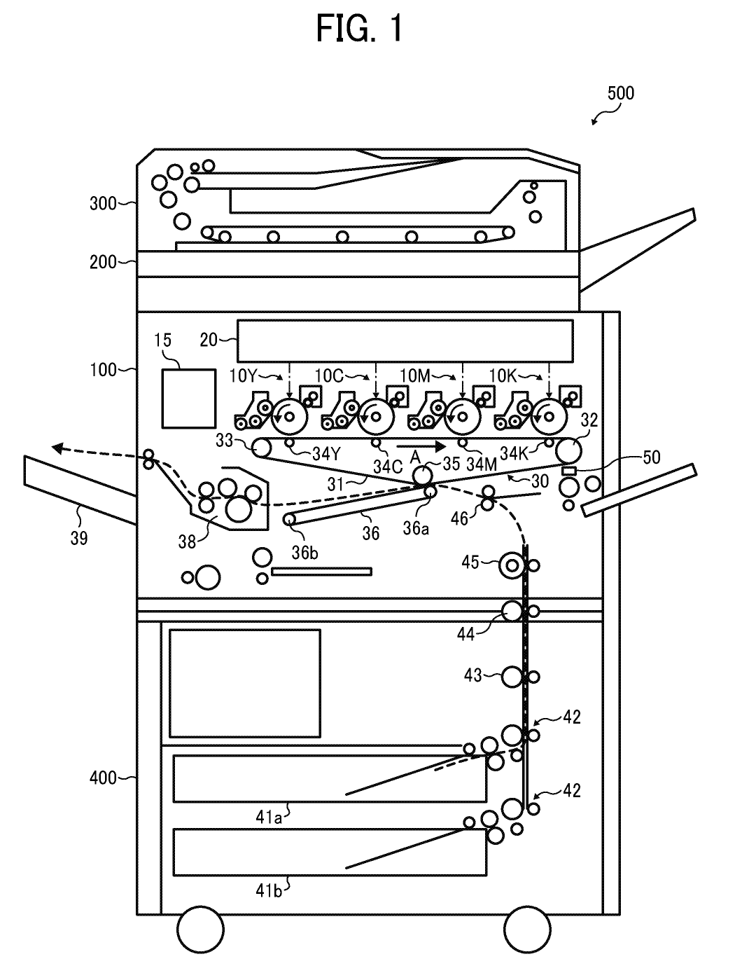

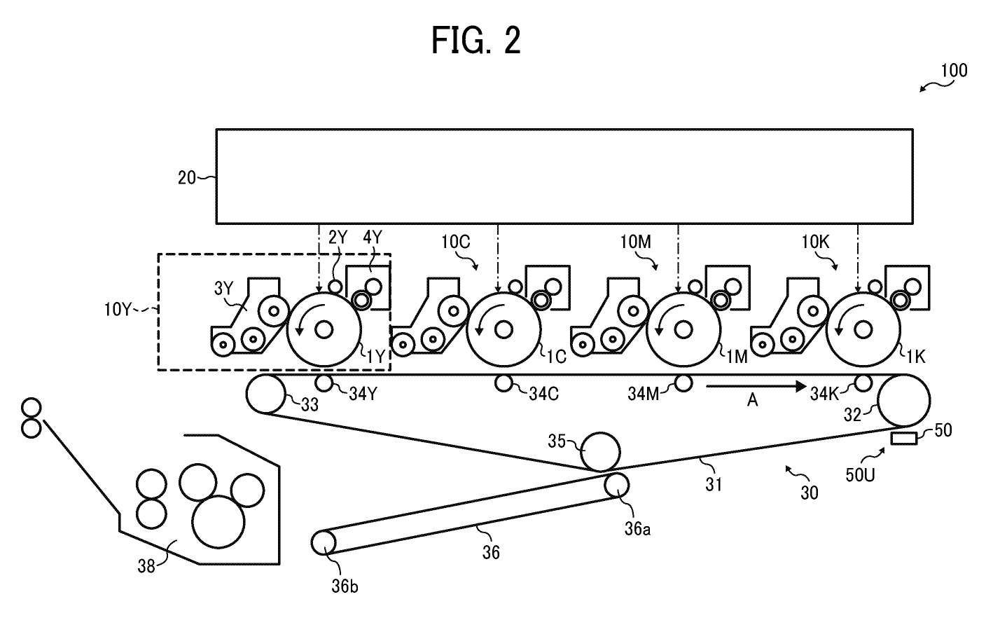

Initially with reference to FIGS. 1 and 2, a description is given of a configuration of an image forming apparatus 500 according to an embodiment of the present disclosure.

FIG. 1 is a schematic view of the image forming apparatus 500. FIG. 2 is a schematic view of an image forming station 100 incorporated in the image forming apparatus 500.

The image forming apparatus 500 may be a copier, a facsimile machine, a printer, a multifunction peripheral or a multifunction printer (MFP) having at least one of copying, printing, scanning, facsimile, and plotter functions, or the like. In the present embodiment, the image forming apparatus 500 is a copier that forms an image on a recording medium by electrophotography.

As illustrated in FIG. 1, the image forming apparatus 500 includes, e.g., the image forming station 100, a sheet feeder 400, a scanner 200, and an automatic document feeder (ADF) 300.

The image forming station 100 forms a toner image on a recording medium. The sheet feeder 400 is a recording medium supplier that supplies the recording medium to the image forming station 100. The scanner 200 is an image reader that reads an image of a document to generate image data. The ADF 300 is a document supplier that automatically feeds the document to the scanner 200.

Inside a housing of the image forming apparatus 500, the image forming station 100 includes a transfer device 30. The transfer device 30 includes an endless intermediate transfer belt 31 as an image bearer and a plurality of rollers that support the intermediate transfer belt 31. The intermediate transfer belt 31 is entrained around the plurality of rollers and formed into a loop. Specifically, the plurality of rollers includes a drive roller 32 rotated by a driver, a driven roller 33, a secondary transfer backup roller 35, and four primary transfer rollers 34Y, 34C, 34M, and 34K.

The intermediate transfer belt 31 is made of, e.g., a stretch-resistant resin material, such as polyimide, in which carbon powder is dispersed to adjust electrical resistance. As the drive roller 32 rotates, the intermediate transfer belt 31 is rotated in a clockwise direction of rotation A as illustrated in FIG. 1 while being supported by the plurality of rollers disposed inside the loop formed by the intermediate transfer belt 31, namely, the drive roller 32, the driven roller 33, the secondary transfer backup roller 35, and the four primary transfer rollers 34Y, 34C, 34M, and 34K.

A primary transfer power source applies a primary transfer bias to each of the four primary transfer rollers 34Y, 34C, 34M, and 34K. The four primary transfer rollers 34Y, 34C, 34M, and 34K are disposed opposite drum-shaped photoconductors 1Y, 1C, 1M, and 1K as latent image bearers and sandwiches the intermediate transfer belt 31 together with the photoconductors 1Y, 1C, 1M, and 1K to form four primary transfer areas herein referred to as primary transfer nips between the intermediate transfer belt 31 and the photoconductors 1Y, 1C, 1M, and 1K. Toner images of yellow, cyan, magenta, and black are formed on the surface of the photoconductors 1Y, 1C, 1M, and 1K, respectively. Then, the toner images of yellow, cyan, magenta, and black are primarily transferred onto an outer circumferential surface of the intermediate transfer belt 31 at the respective primary transfer nips.

The image forming station 100 further includes four image forming devices 10Y, 10C, 10M, and 10K disposed above the transfer device 30, and an optical writing device 20 as a latent image writing device disposed above the image forming devices 10Y, 10C, 10M, and 10K. The optical writing device 20 includes four laser diodes (LDs) driven by a laser controller to emit four laser beams as writing light according to image data of, e.g., an input image to be output. The four image forming devices 10Y, 10C, 10M, and 10K have substantially identical configurations, differing in the color of toner employed. Specifically, the image forming devices 10Y, 10C, 10M, and 10K include the photoconductors 1Y, 1C, 1M, and 1K, respectively, and various pieces of image forming equipment surrounding each of the photoconductors 1Y, 1C, 1M, and 1K.

For example, as illustrated in FIG. 2, the photoconductor 1Y is surrounded by the charger 2Y, the developing device 3Y, and the cleaner 4Y in the image forming device 10Y. The photoconductor 1 is rotated in a counterclockwise direction in FIG. 2. When the photoconductor 1 reaches a position opposite the charger 2, the charger 2 uniformly charges the surface of the photoconductor 1. After the charger 2 uniformly charges the surface of the photoconductor 1, the optical writing device 20 irradiates the charged surface of the photoconductor 1 with the writing light to form an electrostatic latent image on the surface of the photoconductor 1.

In addition to the laser diodes as light sources, the optical writing device 20 includes, e.g., light deflectors such as polygon mirrors, reflection mirrors and optical lenses. In the optical writing device 20, the laser beams emitted by the laser diodes are deflected by the light deflectors, reflected by the reflection mirrors, and pass through the optical lenses to finally reach the surface of each of the photoconductors 1Y, 1C, 1M, and 1K. Thus, the optical writing device 20 writes the electrostatic latent image on the surface of each of the photoconductors 1Y, 1C, 1M, and 1K. Instead of the laser diodes, the optical writing device 20 may include a light emitting diode (LED) array as a light source.

In the image forming device 10, the developing device 3 includes a developing roller as a developer bearer that bears toner. The photoconductor 1 and the developing roller are rotatable and face each other with a predetermined gap, herein referred to as a developing gap, therebetween.

The developing device 3 develops the electrostatic latent image written by the optical writing device 20 on the surface of the photoconductor 1 with the toner born by the developing roller into a visible toner image. Thus, the toner images of yellow, cyan, magenta, and black are formed on the surface of the photoconductors 1Y, 1C, 1M, and 1K, respectively. Then, the toner images of yellow, cyan, magenta, and black are primarily transferred from the photoconductors 1Y, 1C, 1M, and 1K onto the intermediate transfer belt 31 successively at the primary transfer nips such that the toner images of yellow, cyan, magenta, and black are superimposed one atop another on the intermediate transfer belt 31. As a consequence, a composite toner image is formed on the intermediate transfer belt 31. The cleaner 4 removes residual toner that has failed to be transferred onto the intermediate transfer belt 31 and therefore remaining on the surface of the photoconductor 1 from the surface of the photoconductor 1.

As illustrated in FIGS. 1 and 2, the secondary transfer backup roller 35 faces a roller 36a. A conveyor belt 36 is entrained around the roller 36a and a roller 36b, and is formed into a loop. Between the secondary transfer backup roller 35 and the roller 36a, the intermediate transfer belt 31 comes into contact with the conveyor belt 36, thereby forming an area of contact herein referred to as a secondary transfer nip between the intermediate transfer belt 31 and the conveyor belt 36.

Referring back to FIG. 1, the sheet feeder 400 includes, e.g., a plurality of vertically disposed trays 41a and 41b. A recording medium is fed from one of the trays 41a and 41b to a recording medium conveyance passage 42. The recording medium conveyance passage 42 is defined by internal components of the image forming apparatus 500. The recording medium passes through a first conveyance roller pair 43, a second conveyance roller pair 44, and a third conveyance roller pair 45 in this order, and reaches a registration roller pair 46. The activation of the registration roller pair 46 is timed to send the recording medium to the secondary transfer nip such that the recording medium meets the composite toner image formed on the intermediate transfer belt 31 at the secondary transfer nip where the intermediate transfer belt 31 and the conveyor belt 36 meet. Specifically, the toner images of yellow, cyan, magenta, and black constituting the composite toner image are together transferred onto the recording medium by pressure generated at the secondary transfer nip and a secondary transfer electrical field generated by a secondary transfer bias that is applied to the secondary transfer backup roller 35. Thus, a full-color toner image is formed on the recording medium.

After passing through the secondary transfer nip, the recording medium bearing the full-color toner image is conveyed on the conveyor belt 36 to a fixing device 38 as the conveyor belt 36 rotates. In the fixing device 38, the full-color toner image is fixed on the recording medium by heat and pressure generated at an area of contact herein referred to as a fixing nip between two rotators of the fixing device 38. Finally, the recording medium bearing the fixed toner image is ejected onto an output tray 39 disposed outside the housing of the image forming apparatus 500.

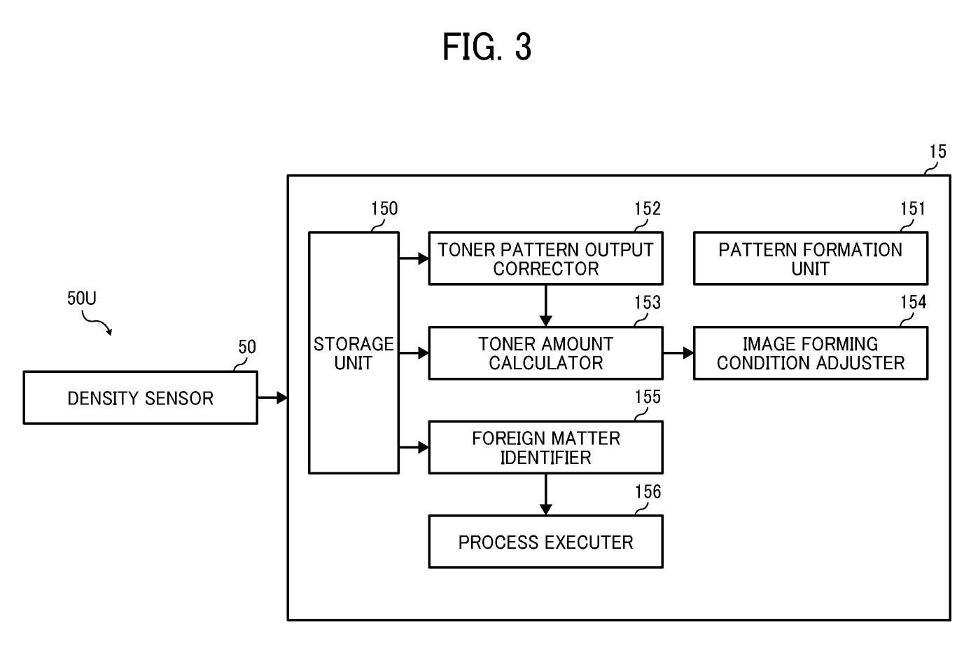

As illustrated in FIG. 1, the image forming apparatus 500 includes a controller 15 to execute various control processes described later. The controller 15 is, e.g., a microprocessor incorporating the functions of a central processing unit (CPU) and provided with, e.g., control circuits, an input/output device, a clock, a timer, and a storage unit 150, as illustrated in FIG. 3, which includes nonvolatile memory and volatile memory. The storage unit 150 of the controller 15 stores various types of control programs and information such as outputs from sensors and calculation data.

The image forming apparatus 500 further includes a density sensor 50 that optically reads the toner image formed on the outer circumferential surface of the intermediate transfer belt 31. The density sensor 50 is disposed downstream from the extreme downstream primary transfer roller 34K among the four primary transfer rollers 34 in the direction of rotation A of the intermediate transfer belt 31. On the other hand, the density sensor 50 is disposed upstream from the secondary transfer nip in the direction of rotation A of the intermediate transfer belt 31.

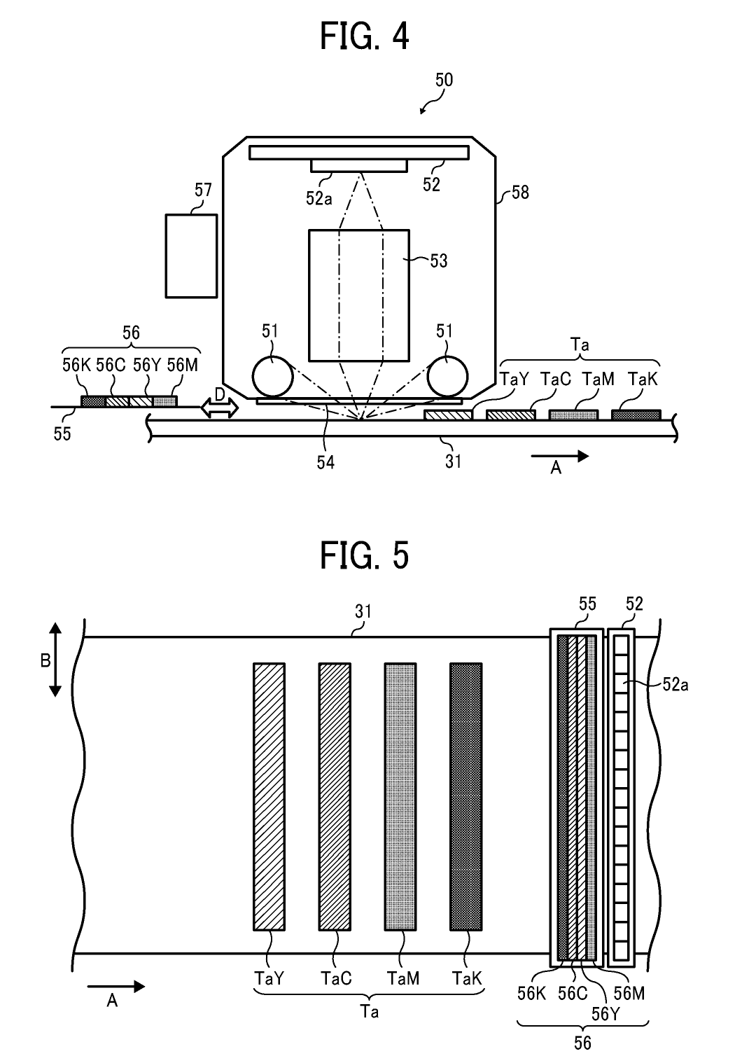

In the present embodiment, a test toner image Ta is formed on the intermediate transfer belt 31 as illustrated in, e.g., FIG. 4 for adjusting density. Specifically, the test toner image Ta is formed under imaging conditions for forming a solid image having a uniform image density in a main scanning direction. The density sensor 50 reads the test toner image Ta. Alternatively, the test toner image Ta may be formed on a recording medium and the density sensor 50 may read the test toner image Ta on the recording medium.

Referring now to FIG. 3, a description is given of a functional structure of the controller 15 operatively connected to the density sensor 50. FIG. 3 is a block diagram illustrating the functional structure of the controller 15.

The controller 15 includes: a pattern formation unit 151; a toner pattern output corrector 152 as an image density detecting condition corrector; a toner amount calculator 153 as an image density calculator; and an image forming condition adjuster 154. The pattern formation unit 151 determines a position to form the test toner image Ta as a toner pattern for adjusting density. The toner pattern output corrector 152 corrects output of the density sensor 50 detecting the test toner image Ta, based on reference data stored in the storage unit 150. The toner amount calculator 153 calculates an amount of toner contained in the test toner image Ta based on the output or readings of the density sensor 50 in a plurality of wavelengths. Specifically, the toner amount calculator 153 calculates the amount of toner by use of a lookup table (LUT) linking the output of the density sensor 50 and the amount of toner. The image forming condition adjuster 154 adjusts one or more image forming conditions based on the amount of toner thus calculated.

The controller 15 further includes a foreign matter identifier 155 and a process executer 156. The foreign matter identifier 155 identifies foreign matter in the density sensor 50. The process executer 156 executes a process in response to identification by the foreign matter identifier 155.

In the present embodiment, an image density detector 50U includes, e.g., the density sensor 50, the toner pattern output corrector 152, the toner amount calculator 153, the foreign matter identifier 155, and the process executer 156 described above.

Referring now to FIGS. 4 through 6, a detailed description is given of a construction of the density sensor 50.

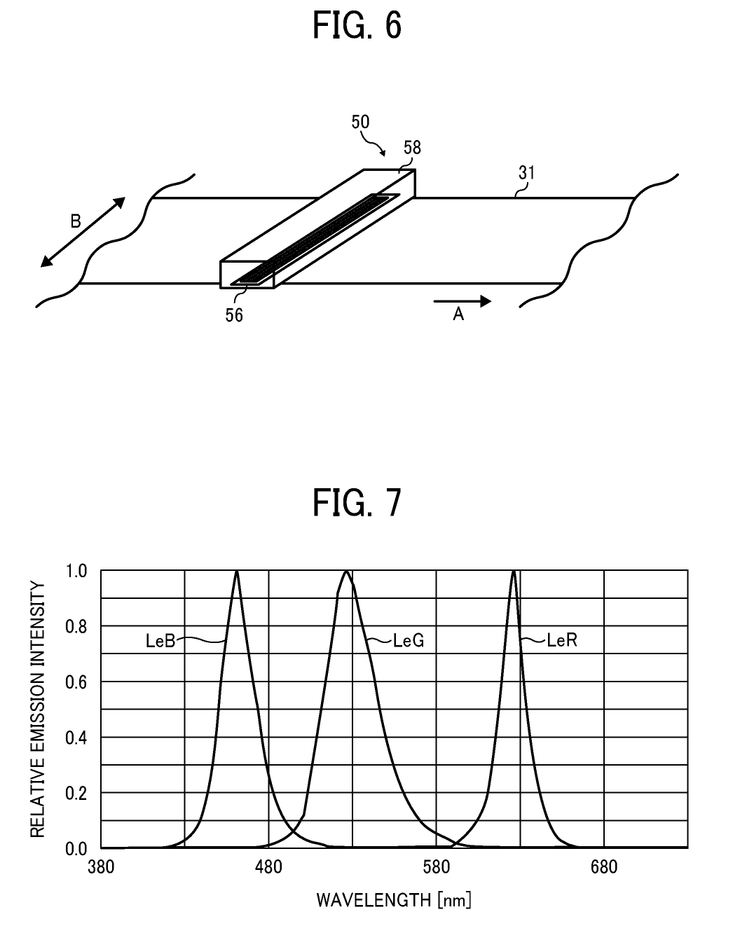

FIG. 4 is a cross-sectional side view of the density sensor 50. FIG. 5 is a plan view of the line sensor 52, a reference board 56 mounted on a shutter 55, and the test toner image Ta formed on the intermediate transfer belt 31, illustrating relative positions thereof. FIG. 6 is a perspective view of the density sensor 50 and the intermediate transfer belt 31.

As illustrated in FIG. 4, the density sensor 50 includes a housing 58 that accommodates a light source 51 as a light emitter, a line sensor 52 as a light receiver, and a lens array 53. The line sensors often include a plurality of image sensors aligned in one or more lines to convert light intensity into an electrical signal. In the present embodiment, as illustrated in FIG. 5, the line sensor 52 includes a plurality of image sensors 52a aligned in one line in a width direction B of the intermediate transfer belt 31 perpendicular to the direction of rotation A of the intermediate transfer belt 31.

Since the density sensor 50 includes the line sensor 52 as a light receiver, the density sensor 50 detects the amount of toner contained in the test toner image Ta formed on the intermediate transfer belt 31, throughout an entire width of the intermediate transfer belt 31 in the width direction B parallel to the main scanning direction.

Referring back to FIG. 4, the housing 58 has an opening on a side facing the intermediate transfer belt 31. A transparency 54 covers the opening of the housing 58 to allow transmission of light through the opening of the housing 58. The shutter 55 moves in a direction of movement D between the housing 58 and the intermediate transfer belt 31. Specifically, the shutter 55 moves in the direction of movement D to a position where the shutter 55 faces the transparency 54 or to a position where the shutter 55 does not face the transparency 54. The reference board 56 is secured to a surface of the shutter 55 capable of facing the transparency 54.

FIG. 6 is a perspective view of the density sensor 50 and the intermediate transfer belt 31, illustrating that the reference board 56 is located opposite the opening of the housing 58, and therefore facing the transparency 54.

As illustrated in FIG. 4, the density sensor 50 includes a temperature sensor 57 disposed outside the housing 58 to detect the temperature in the vicinity of the density sensor 50.

On an end of a light guide of the light source 51 are light emitting diodes or RGB LEDs that emit red (R), green (G), and blue (B) light, respectively. When the light source 51 emits the red, green, and blue light sequentially, the image sensors 52a detect reflection light of each of the red, green, and blue light. Since a plurality of LEDs is aligned in a width direction of the light source 51 parallel to the width direction B, the light source 51 irradiates the outer circumferential surface of the intermediate transfer belt 31 or the surface of the reference board 56 with light rays that extend in the width direction B of the intermediate transfer belt 31 and a width direction of the reference board 56 parallel to the width direction B.

The image sensors 52a receive light focused by the lens array 53 and output a signal corresponding to the light received. The image sensors 52a may be, e.g., complementary metal oxide semiconductor (CMOS) image sensors, charge-coupled device (CCD) image sensors, or the like.

The lens array 53 includes, e.g., a SELFOC® lens.

In the density sensor 50 of the present embodiment, the light source 51 as a light emitter is the plurality of LEDs (i.e., RGB LEDs) that emits red, green, and blue light. In the line sensor 52 as a light receiver, the image sensors 52a are aligned in a line. Alternatively, for example, the light source 51 may be an LED that emits white light. In the line sensor 52, the image sensors 52a may be aligned in three lines. In this case, red, green, and blue filters may be mounted on the surface of the image sensors 52a in the three lines, respectively. In this configuration, the image sensors 52a receive reflection light of the white light as red, green, or blue light depending on the colors of the filters mounted on the surface of the image sensors 52a.

In the present embodiment, the density sensor 50 is a contact image sensor (CIS). Alternatively, the density sensor 50 may be a sensor employing a reduction optical system.

As specifically illustrated in FIGS. 4 and 5, the reference board 56 includes a cyan reference board 56C, a magenta reference board 56M, a yellow reference board 56Y, and a black reference board 56K to color the surface of the reference board 56 in cyan, magenta, yellow, and black, respectively.

The reference board 56 has a width, which is a length in the width direction B, greater than a reading width of the line sensor 52, which is a length in the width direction B within which the line sensor 52 reads light reflected from a toner image formed on the outer circumferential surface of the intermediate transfer belt 31. Each of the cyan, magenta, yellow, and black reference boards 56C, 56M, 56Y, and 56K has a uniform color (i.e., uniform spectral reflectance distribution) throughout an entire width thereof. Output data of the image sensors 52a receiving light reflected from the reference board 56 is used for a shading correction described later.

As illustrated in FIG. 4, the reference board 56 is mounted on the surface or back surface of the shutter 55 capable of covering the opening of the housing 58. The density sensor 50 detects light reflected from the surface of the reference board 56 when the shutter 55 is closed, covering the opening of the housing 58. On the other hand, the density sensor 50 detects light reflected from the toner image formed on the outer circumferential surface of the intermediate transfer belt 31 when the shutter 55 is opened, moving to the position where the shutter 55 does not cover the opening of the housing 58.

Generally, image forming apparatuses include a reflective photosensor or photoreflector to detect various types of information on an image bearer such as an intermediate transfer belt, so as to use the readings of the reflective photosensor for image quality adjustment. For example, the reflective photosensor detects an amount of toner contained in a test toner image for adjusting image density, or detects positional information for adjusting displacement. The reflective photosensor may further detect contamination or damage on the surface of a toner image bearer such as a photoconductor, and may detect variation in sensitivity of the photoconductor.

In a production printing field, stable image density is important not only between pages but also within a page. Since a line sensor detects image density throughout an entire area in the main scanning direction, the line sensor detects unevenness in image density caused by misalignment in the main scanning direction within a page. Based on the unevenness in image density detected by the line sensor, image forming conditions are adjusted to keep the image density stable within the page. The line sensor may be, e.g., a CIS incorporated in a reading unit of a scanner or a sensor incorporated in a reduction optical system unit.

The density sensors that detect the image density may often include a line sensor as a light receiver that includes a plurality of image sensors. The image sensors may output different data from each other even if the line sensor detects light reflected from an image having a uniform image density.

For example, if the image sensors differ in spectral sensitivity distribution, the line sensors may output different data from each other. That is, even if the line sensor receives reflection light that is uniform in a width direction thereof, the image sensors may output different data from each other, thus causing errors in the output of the image sensors.

On the other hand, the amount of light emitted by the light emitting devices to an image and spectral distributions of the light emitting devices may vary, e.g., in a width direction of an image bearer (e.g., an intermediate transfer belt) on which the image is irradiated with the light. Further, the amount of light emitted by the light emitting devices and the spectral distributions of the light emitting devices may vary depending on the position of the image relative to a light source that includes the light emitting devices in the width direction of the image bearer. Such variation may cause the image sensors to receive different amounts of light reflected from the image in the width direction of the image bearer. Relatedly, the image sensors may differ in the spectral distribution. That is, even if all the image sensors have identical spectral sensitivity distributions, the image sensors may output different data from each other, thus causing errors in the output of the image sensors.

To address this circumstance, image forming apparatuses often include a white reference board having an even density in a width direction thereof to correct the output of the image sensors. Specifically, for example, the light emitter irradiates the white reference board with light and the light receiver (e.g., line sensor) receives the light reflected from the white reference board. Output data of the image sensors of the line sensor is used as reference data and stored in a storage unit of a controller of the image forming apparatuses. Based on the reference data, output data of the image sensors receiving light reflected from a test toner image is corrected. As a consequence, the errors in output of the image sensors may be reduced to some extent.

However, such correction based on the measured amount of reflection light from the white reference board may be insufficient to correct an image density detecting condition (e.g., measured amount of light received) as appropriate. As a consequence, an inaccurate image density might be detected.

Specifically, for example, the spectral reflectance distribution is different between the surface of the test toner image and the white reference board. Accordingly, as described later in detail, variation in light-receiving characteristics of the image sensors and in light-emitting characteristics of the light emitting devices may hamper reduction of the errors in output of the image sensors.

If all the image sensors have identical light-receiving characteristics and all the light emitting devices have identical light-emitting characteristics, the errors in output of the image sensors may be reduced. However, to accomplish such a level, the production cost may increase substantially.

Alternatively, the density sensor may include a light source that emits infrared light instead of visible light and a light receiver that detects the infrared light. However, such a density sensor may require increased cost.

Hence, in the present embodiment, the density sensor 50 includes the reference board 56 having a color identical to a color of the test toner image Ta. Output data of the image sensors 52a receiving light reflected from the reference board 56 is used as reference data. Detecting conditions of the test toner image Ta is corrected based on the reference data.

For example, before detection of an amount of toner contained in a cyan test toner image TaC, the cyan reference board 56C is irradiated with light and output data of the image sensors 52a is stored as reference data. Based on the reference data, output data of the image sensors 52a receiving light reflected from the test toner image TaC is corrected. Based on the output data of the image sensors 52a thus corrected, the amount of toner contained in the test toner image TaC is calculated for each detection area of the image sensors 52a.

Similarly, an amount of toner contained in each of magenta, and yellow, and black test toner images TaM, TaY, and TaK is calculated. Accordingly, an accurate amount of toner contained in the test toner image Ta is detected regardless of variation in the light-emitting characteristics of the LEDs as light emitting devices of the light source 51 and variation in the light-receiving characteristics of the image sensors 52a.

Correction of the detecting conditions of the test toner image Ta is not limited to the correction described above in which the output data of the image sensors 52a receiving the light reflected from the test toner image Ta is corrected based on the reference data. Alternatively, based on the reference data, output of the LEDs and/or the sensitivity of the image sensors 52a may be adjusted to correct the detecting conditions of the test toner image Ta.

FIG. 7 is a graph illustrating an example of spectral distributions of the red, green, and blue light emitted by the RGB LEDs.

In FIG. 7, “LeB” represents an example of the spectral distribution of the blue light. “LeG” represents an example of the spectral distribution of the green light. “LeR” represents an example of the spectral distribution of the red light.

As illustrated in FIG. 7, each of the red, green, and blue light emitted by the RGB LEDs of the light source 51 has a spectral distribution in a visible spectrum. The LEDs may have different light-emitting characteristics from each other, such as a center wavelength of a spectral distribution of light emitted, due to production tolerances.

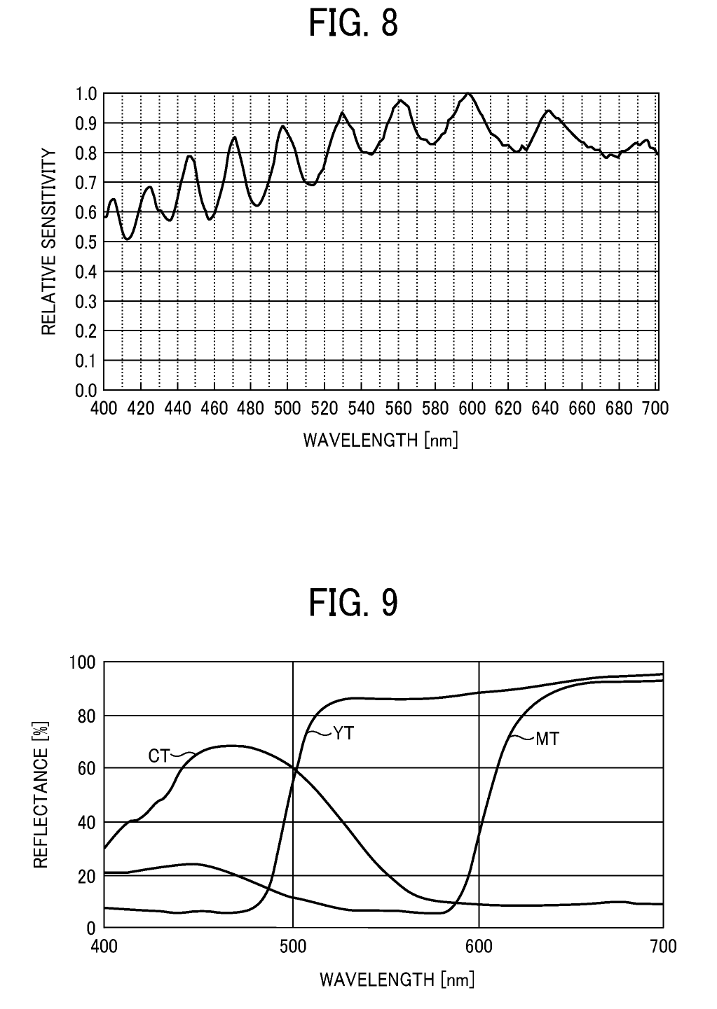

FIG. 8 is a graph illustrating an example of a spectral sensitivity distribution of one of the image sensors 52a.

As illustrated in FIG. 8, the image sensor 52a has a spectral sensitivity distribution in the visible spectrum. The image sensors 52a may have different light-receiving characteristics from each other, such as a spectral sensitivity distribution to convert received light into an electrical signal, due to production tolerances.

FIG. 9 is a graph illustrating an example of spectral reflectance distributions of cyan, yellow, and magenta toner images.

In FIG. 9, “CT”, “YT”, and “MT” represent the spectral reflectance distributions of the cyan, yellow, and magenta toner images, respectively. The different color toner images may have different spectral reflectance distributions from each other due to production tolerances, and depending on the toner used and the image forming devices to form the toner images.

For detection of an amount of toner in a toner image, one of the red, green, and blue light emitted from the light source 51 is used. Specifically, a spectrum (i.e., range of wavelengths) with a maximum emission intensity of the one of the red, green, and blue light is closer to a spectrum with a maximum reflectance of the toner image than a spectrum with a maximum emission intensity of the rest of the red, green, and blue light.

For example, in FIG. 9, the spectral reflectance distribution “CT” illustrates that the cyan toner image has the maximum reflectance in the vicinity of a wavelength of 470 nm. Similarly, the spectral reflectance distributions “YT” and “MT” respectively illustrate that the yellow and magenta toner images have reflectance increasing in a spectrum of from 400 nm to 700 nm.

Referring back to FIG. 7, the red, green, and yellow light have maximum emission intensities in the vicinity of wavelengths of 620 nm, 520 nm, and 460 nm, respectively.

Although red, green, and blue outputs can be obtained for each of the cyan, yellow, and magenta toner images from each of the image sensors 52a, an amount of toner contained in the cyan toner image is calculated by use of the output of the image sensors 52a receiving the blue light emitted to and reflected from the cyan toner image. Similarly, for detection of an amount of toner contained in the magenta toner image, the magenta toner image is irradiated with the red light. For detection of an amount of toner contained in the yellow toner image, the yellow toner image is irradiated with the red light.

With regard to calculation of an amount of black toner, a black toner image is superimposed on one of the cyan, magenta, and yellow toner images to form a pattern image. The amount of black toner contained in the pattern image is calculated by use of the output of the image sensors 52a receiving light emitted to and reflected from the pattern toner image. In the present embodiment, the intermediate transfer belt 31 is black. If the black toner image is formed on the black intermediate transfer belt 31, the amount of black toner might be detected inaccurately because of a relatively small difference of reflectance between the black toner and the black intermediate transfer belt 31. Hence, in the present embodiment, the black toner image is superimposed on a color toner image, that is, one of the cyan, magenta, and yellow toner images to form the pattern image such that the black toner image and the color toner image differ in the amount of toner contained. The density sensor 50 reads the pattern image to detect the image density of black toner image based on the difference of reflectance between the black toner contained in the black toner image and color toner contained in the color toner image.

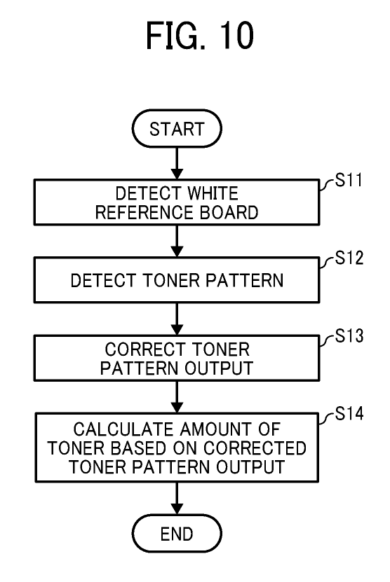

Referring now to FIGS. 10 through 17, a description is given of comparative circumstances raised by use of the white reference board instead of the reference board 56 of the present embodiment.

FIG. 10 is a flowchart of a comparative process of calculating an amount of toner contained in the test toner image Ta by use of the white reference board.

In step S11, the line sensor 52 detects the white reference board. The storage unit 150 of the controller 15 stores an output of each of the image sensors 52a.

In step S12, the test toner image Ta (hereinafter referred to as a toner pattern) is formed on the outer circumferential surface of the intermediate transfer belt 31. The line sensor 52 detects the test toner image Ta. The storage unit 150 of the controller 15 stores an output of each of the image sensors 52a (hereinafter referred to as a toner pattern output).

In step S13, the output of each of the image sensors 52a upon detection of the test toner image Ta (i.e., toner pattern output) is corrected based on the stored output of each of the image sensors 52a upon detection of the white reference board as a reference.

In step S14, an amount of toner contained in the test toner image Ta is calculated for each detection area of the image sensors 52a, based on the toner pattern output thus corrected (hereinafter referred to as corrected toner pattern output).

Based on the amount of toner thus calculated, image forming conditions are modified with respect to a defective portion of the test toner image Ta where the amount of toner contained is out of a given range. Specifically, the optical writing device 20 emits a laser beam with a modified emission intensity to a surface of the photoconductor 1 corresponding to the defective portion of the test toner image Ta. In short, a writing intensity to write an electrostatic latent image is modified such that the amount of toner contained in the defective portion of the test toner image Ta is in the given range.

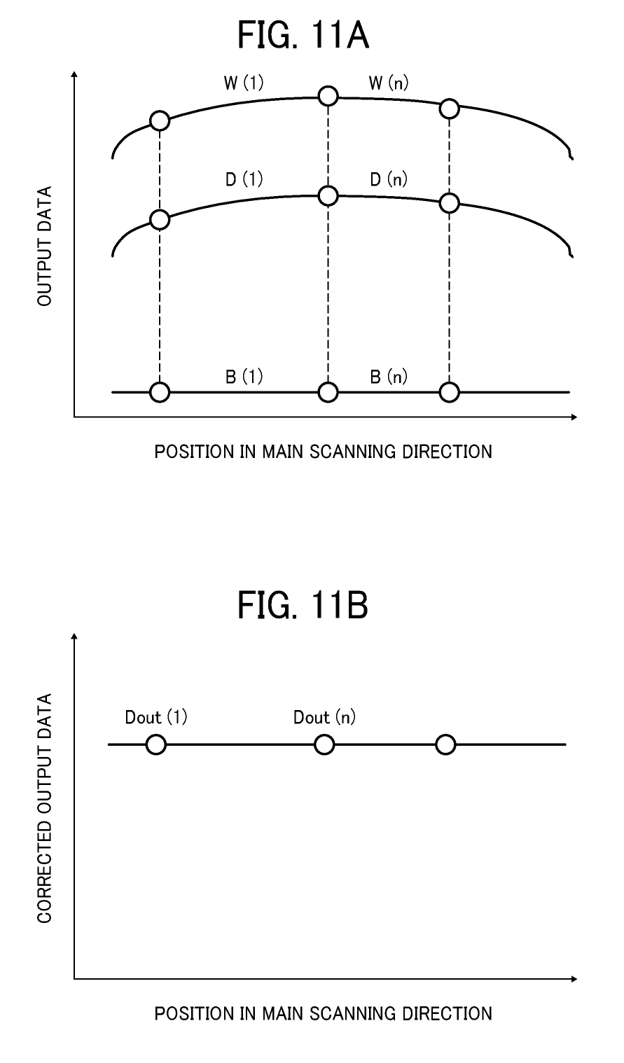

FIGS. 11A and 11B illustrate a comparative shading correction of correcting detected data of the test toner image Ta based on detected data of the white reference board.

In FIGS. 11A and 11B, the horizontal axis indicates the position of the image sensors 52a in the main scanning direction. FIG. 11A is a graph illustrating a relationship between output data of the image sensors 52a and the position of the image sensor 52a in the main scanning direction. A bracketed “n” represents a number designated to each of the image sensors 52a. “W(n)” represents output data of the image sensors 52a upon detection of the white reference board. “D(n)” represents output data of the image sensors 52a upon detection of the test toner image Ta containing a uniform amount of toner therewithin. “B(n)” represents output data of the image sensors 52a when the light source 51 is turned off.

FIG. 11B is a graph illustrating a relationship between corrected output data of the image sensors 52a and the position of the image sensors 52a in the main scanning direction. In FIG. 11B, “Dout(n)” represents corrected data of the output data of the image sensors 52a upon detection of the test toner image Ta. Since the test toner image Ta contains a uniform amount of toner therewithin, even corrected output data is obtained as illustrated in FIG. 11B based on the output data of FIG. 11A and Equation 1 below:

$$Dout ( n ) = \frac{D ( n ) - B ( n )}{W ( n ) - B ( n )} \times 255. \qquad Equation 1$$

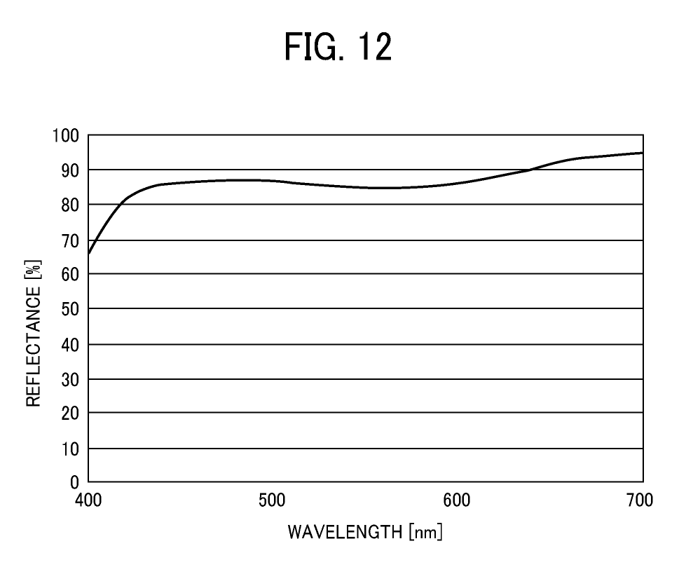

FIG. 12 is a graph illustrating an example of a spectral reflectance distribution of the white reference board.

Usually, white reference boards may have different spectral reflectance distributions from each other due to production tolerances.

As illustrated in FIGS. 9 and 12, the white reference board has a significantly different spectral reflectance distribution from the spectral reflectance distributions of the cyan, yellow, and magenta toner images.

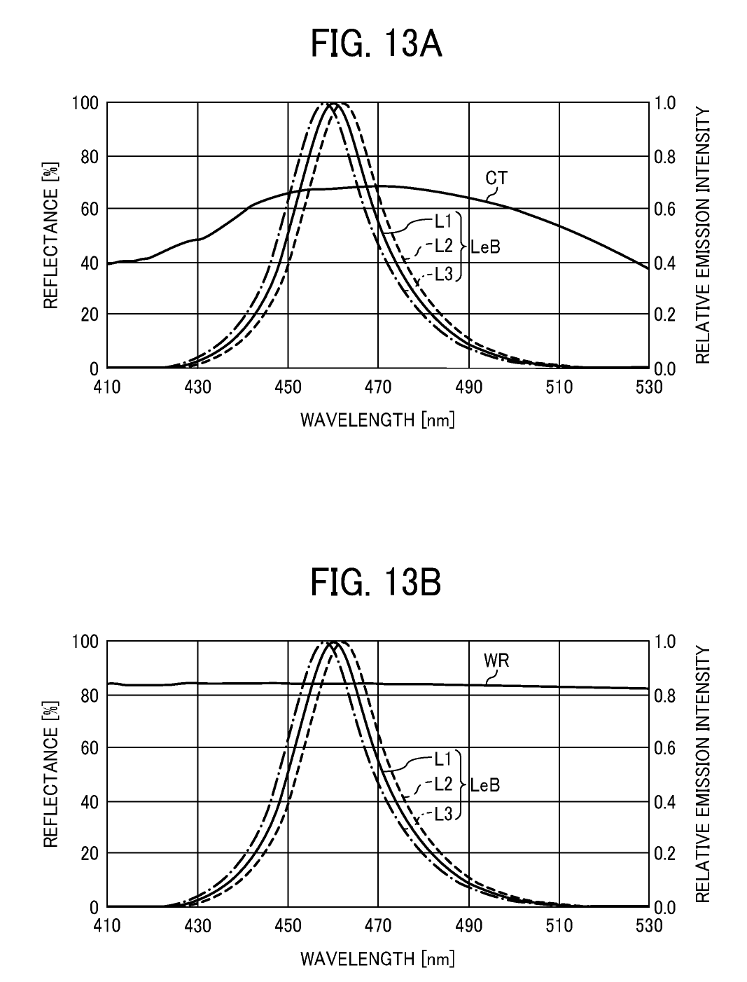

FIG. 13A is a graph illustrating the spectral reflectance distribution of the cyan toner image and the spectral distribution of the blue light. FIG. 13B is a graph illustrating the spectral reflectance distribution of the white reference board and the spectral distribution of the blue light.

In FIGS. 13A and 13B, “LeB” represents the spectral distribution of the blue light, which varies due to the difference of LEDs as illustrated by a solid line L1 and broken lines L2 and L3. In FIG. 13A, “CT” represents the spectral reflectance distribution of the cyan toner image. In FIG. 13B, “WR” represents the spectral reflectance distribution of the white reference board.

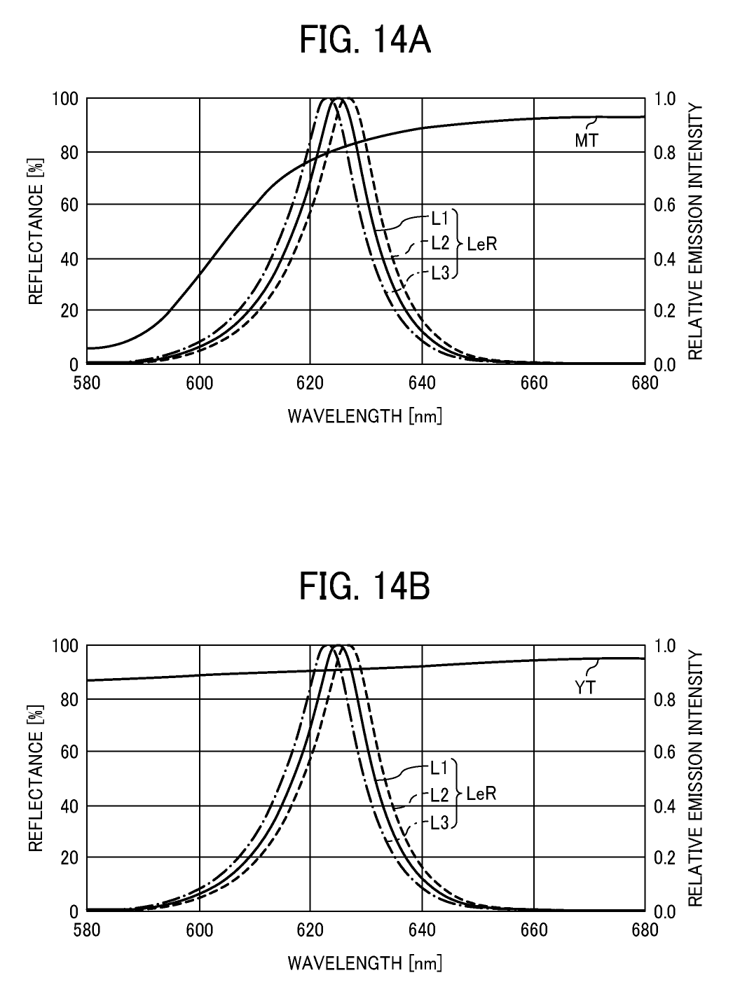

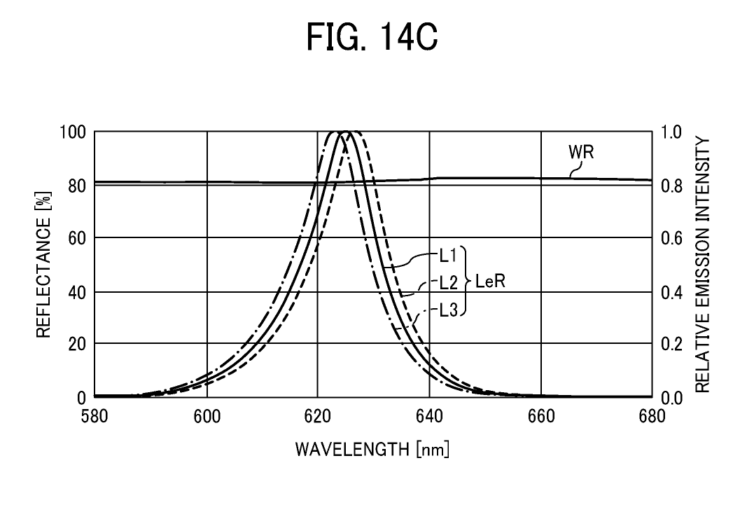

FIG. 14A is a graph illustrating the spectral reflectance distribution of the magenta toner image and the spectral distribution of the red light. FIG. 14B is a graph illustrating the spectral reflectance distribution of the yellow toner image and the spectral distribution of the red light. FIG. 14C is a graph illustrating the spectral reflectance distribution of the white reference board and the spectral distribution of the red light.

In FIGS. 14A through 14C, “LeR” represents the spectral distribution of the red light, which varies due to the difference of LEDs as illustrated by the solid line L1 and the broken lines L2 and L3. In FIG. 14A, “MT” represents the spectral reflectance distribution of the magenta toner image. In FIG. 14B, “YT” represents the spectral reflectance distribution of the yellow toner image. In FIG. 14C, “WR” represents the spectral reflectance distribution of the white reference board.

The output of the image sensors 52a upon detection of an amount of toner depends on a sum of values in an entire spectrum. Each of the values is obtained by “amount of light emitted by LED”×“reflectance of toner image”×“sensitivity of image sensor” for each wavelength. For example, if an emission intensity is high and a spectral reflectance of the toner image is low at a common wavelength, the output of the image sensor 52a decreases. If the emission intensity and the spectral reflectance of the toner image are high and a spectral sensitivity of the image sensor 52a is low at a common wavelength, the output of the image sensor 52a decreases.

The output of the image sensors 52a upon detection of the reference board 56 depends on a sum of values in the entire spectrum. Each of the values is obtained by “amount of light emitted by LED”×“reflectance of reference board”×“sensitivity of image sensor” for each wavelength.

The toner image and the white reference board differ in spectral reflectance distribution.

The white reference board has a relatively high reflectance throughout an entire visible spectrum. On the other hand, the toner image has a decreased reflectance in a certain spectrum. In the spectrum, the “reflectance of reference board” and the “reflectance of toner image” described above are different.

Therefore, variation in the light-emitting characteristics of the LEDs or in the light-receiving characteristics of the image sensors 52a may affect detected amount of light reflected from the toner image on the one hand, such variation may not affect detected amount of light reflected from the white reference board on the other hand. A description is now given of an example of such a case, taking variation in wavelength with a maximum amount of emitted light.

As illustrated in FIG. 13B, the reflectance of the white reference board hardly fluctuates at any light wavelength. Therefore, even when the spectral distribution of the emitted light varies and therefore the peak thereof varies, the reflectance of the white reference board hardly changes around the peak of the spectral distribution of the emitted light. In other words, even when the spectrum with a highest intensity of the emitted light changes, the reflectance of the white reference board hardly changes around the peak of the spectral distribution of the emitted light.

Accordingly, if the LEDs emitting an identical total amount of light throughout the entire spectrum have different peaks in the spectral distributions thereof, a total amount of light reflected from the white reference board hardly fluctuates throughout the entire spectrum. At the same time, if the image sensors 52a have identical, constant spectral sensitivities throughout the entire spectrum, the image sensors 52a exhibit identical outputs.

On the other hand, as illustrated in FIG. 13A, the reflectance of the cyan toner image fluctuates depending on the light wavelength. Therefore, when the spectral distribution of the emitted light varies and therefore the peak thereof varies, the reflectance of the toner image changes around the peak of the spectral distribution of the emitted light.

Accordingly, if the toner image has a uniform image density therewithin and if the LEDs emitting an identical total amount of light throughout the entire spectrum have different peaks in the spectral distributions thereof, a total amount of light reflected from the cyan toner image fluctuates throughout the entire spectrum. As a consequence, even if the image sensors 52a have identical, constant spectral sensitivities throughout the entire spectrum, the image sensors 52a exhibit different outputs depending on the peak of the spectral distribution of the light emitted by the LEDs.

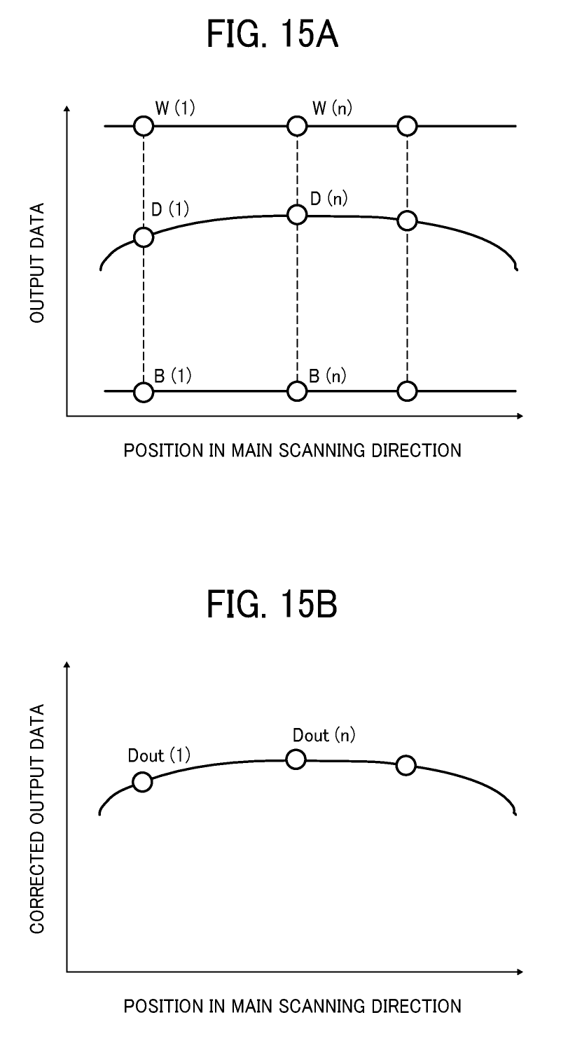

FIGS. 15A and 15B illustrate a shading correction executed when the image sensors 52a exhibit identical outputs upon detection of the white reference board while the image sensors 52a exhibit different outputs upon detection of the test toner image Ta containing a uniform amount of toner therewithin. FIG. 15A is a graph illustrating a relationship between the output data of the image sensors 52a and the position of the image sensors 52a in the main scanning direction. FIG. 15B is a graph illustrating a relationship between corrected output data of the image sensors 52a and the position of the image sensors 52a in the main scanning direction.

When the output data of the image sensors 52a illustrated in FIG. 15A is corrected by Equation 1 above, the corrected output data of the image sensors 52a varies as illustrated in FIG. 15B, even if the toner image has a uniform amount of toner therewithin. That is, FIG. 15B illustrates as if the toner image is uneven in the amount of toner contained.

Thus, variation in the light-emitting characteristics of the light emitting devices of the light source 51 may hamper accurate correction of the output data of the image sensors 52a in accordance with an actual amount of toner contained in the toner image. Calculation of the amount of toner based on such inaccurately corrected output data of the image sensors 52a may cause detection error of toner amount.

Unfavorable circumstances may be raised by variation in the light-emitting characteristics of the LEDs or in the light-receiving characteristics of the image sensors 52a in a spectrum with a relatively low reflectance of the toner image. In other words, the variation in the light-emitting characteristics of the LEDs or in the light-receiving characteristics of the image sensors 52a that does not affect detected amount of light reflected from the toner image may affect detected amount of light reflected from the white reference board. The variation in the light-emitting characteristics of the LEDs or in the light-receiving characteristics of the image sensors 52a may have different impacts on the detected amount of light reflected from the toner image and on the detected amount of light reflected from the white reference board. As a consequence, detection error of toner amount may occur.

Such detection error of toner amount may be caused not only by the variation in the spectral distribution of light emitted from the light source 51 but also by the variation in the spectral sensitivity distribution of the image sensors 52a as illustrated in FIG. 8.

The unfavorable circumstances described above may be raised not only in detection of the cyan toner image but also in detection of the magenta and yellow toner images.

Further, the unfavorable circumstances may be raised not only when a light source that emits red, green, and blue light is used but also when a light source that emits white light and the image sensors are provided with red, green, and blue filters, respectively.

The above description includes detection error of toner amount caused by a line sensor that includes a plurality of image sensors. However, a sensor that includes at least one light receiving device (e.g., image sensor 52a) may cause such detection error of toner amount when the white reference board is used.

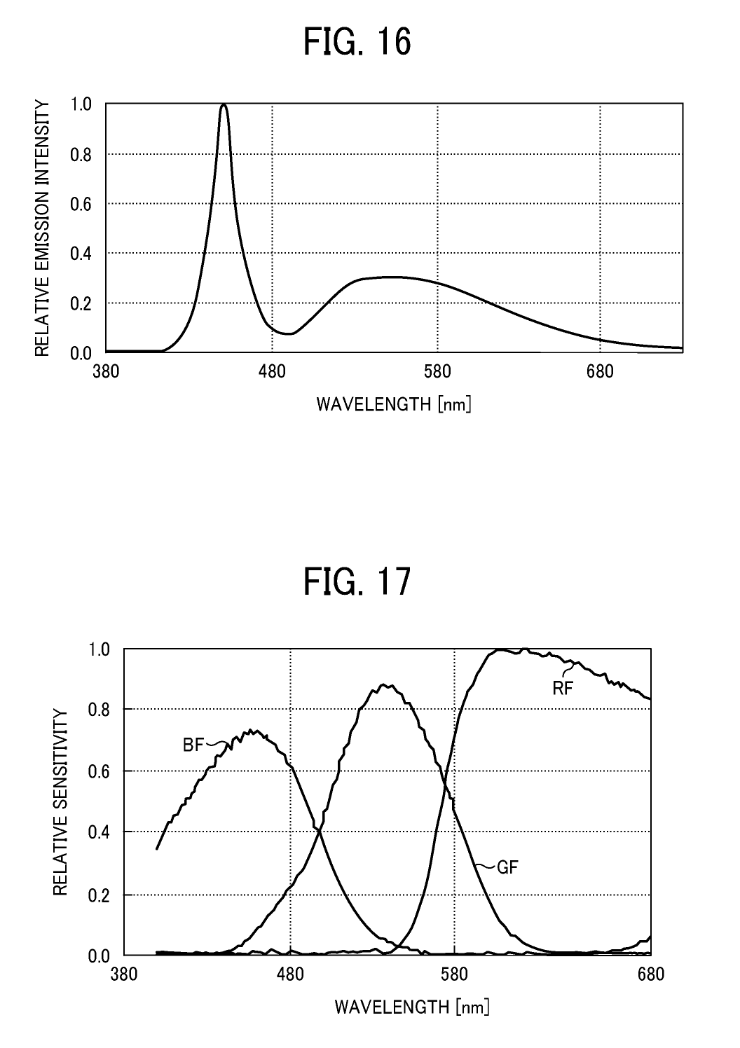

Referring now to FIGS. 16 and 17, a description is given a comparative light source that emits white light.

FIG. 16 is a graph illustrating an example of a spectral distribution of an LED incorporated in the comparative light source that emits white light. The white light illustrated in FIG. 16 has a spectral distribution in a visible spectrum. LEDs that emit white light may have different light-emitting characteristics from each other, such as a center wavelength of a spectral distribution, due to production tolerances.

FIG. 17 is a graph illustrating an example of spectral sensitivity distributions of comparative image sensors provided with red, green, and blue filters, respectively. In FIG. 17, “BF”, “GF”, and “RF” represent of the spectral sensitivity distributions of the comparative image sensors provided with red, green, and blue filters, respectively. Each of the comparative image sensors provided with red, green, and blue filters has a spectral sensitivity distribution in a visible spectrum. The comparative image sensors provided with red, green, and blue filters may have different light-receiving characteristics from each other, such as a spectral sensitivity distribution to convert received light into an electrical signal, due to production tolerances.

If detected data of the white reference board is used as reference data for correcting different outputs of the comparative image sensors upon detection of the toner image, such different spectral distributions of the LEDs and different spectral sensitivity distributions of the comparative image sensors may hamper accurate correction of the different outputs of the comparative image sensors.

Hence, in the present embodiment, the reference board 56 constituted of cyan, yellow, magenta, and black reference boards 56C, 56Y, 56M, and 56K is used.

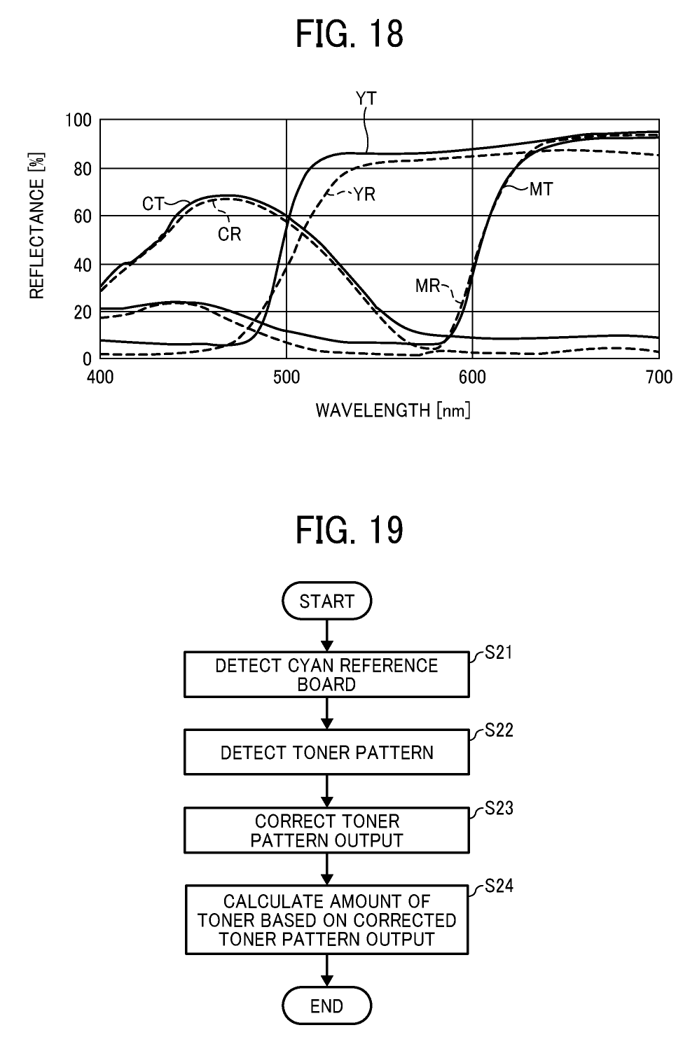

FIG. 18 is a graph illustrating an example of the spectral reflectance distributions of the cyan, yellow, and magenta toner images and spectral reflectance distributions of the cyan, yellow, and magenta reference boards 56C, 56Y, and 56M.

In FIG. 18, “CT”, “YT”, and “MT” represent the spectral reflectance distributions of the cyan, yellow, and magenta toner images, respectively. On the other hand, “CR”, “YR”, and “MR” represent the spectral reflectance distributions of the cyan, yellow, and magenta reference boards 56C, 56Y, and 56M, respectively. The cyan, yellow, and magenta reference boards 56C, 56Y, and 56M are produced by use of “FINALPROOF” made by Fuji Photo Film. Co. Ltd.

FIGS. 9 and 18 illustrate the spectral reflectance distributions of the cyan, yellow, and magenta toner images that are fixed on a white recording medium.

More specifically, FIGS. 9 and 18 illustrate the spectral reflectance distributions of the cyan, yellow, and magenta toner as image forming materials contained in the cyan, yellow, and magenta toner images, respectively, that are fixed on the white recording medium. Alternatively, for example, experiments may be conducted to measure the spectral reflectance distributions of toner adhering to an image bearer such as the intermediate transfer belt 31, on which a toner image is formed. In this case, the density sensor 50 detects an amount of the toner adhering to the image bearer.

As described above, the image forming apparatus 500 includes the image forming devices 10C, 10M, and 10Y to form the cyan, magenta, and yellow toner images, respectively. In the spectrum of from 400 nm to 700 nm, according to the spectral reflectance distribution of the cyan toner contained in the solid toner image fixed on the white recording medium, the reflectance of the cyan toner becomes 70% of a difference between a maximum reflectance and a minimum reflectance of the cyan toner in spectra of 420±20 nm and 510±20 nm. According to the spectral reflectance distribution of the magenta toner contained in the solid toner image fixed on the white recording medium, the reflectance of the magenta toner becomes 70% of a difference between a maximum reflectance and a minimum reflectance of the magenta toner in a spectrum of 610±20 nm. According to the spectral reflectance distribution of the yellow toner contained in the solid toner image fixed on the white recording medium, the reflectance of the yellow toner becomes 70% of a difference between a maximum reflectance and a minimum reflectance of the yellow toner in a spectrum of 510±20 nm.

In the present embodiment, the image forming apparatus 500 includes the reference board 56 having a spectral reflectance distribution conforming to a spectral reflectance distribution of the toner image formed by at least one of the four image forming devices 10. Specifically, for example, the reference board 56 includes the cyan reference board 56C having a spectral reflectance distribution identical or close to a spectral reflectance distribution of the cyan toner image formed by the image forming device 10C. Similarly, the reference board 56 includes the magenta reference board 56M having a spectral reflectance distribution identical or close to a spectral reflectance distribution of the magenta toner image formed by the image forming device 10M. The reference board 56 further includes the yellow reference board 56Y having a spectral reflectance distribution identical or close to a spectral reflectance distribution of the yellow toner image formed by the image forming device 10Y.

For example, for detecting an amount of toner contained in the cyan toner image, output data of the image sensors 52a receiving light emitted to and reflected from the cyan toner image is corrected by use of output data of the image sensors 52a receiving light emitted to and reflected from the cyan reference board 56C. Thus, in the present embodiment, the reference board 56 is used for the shading correction because, compared to the white reference board, the reference board 56 has a spectral reflectance distribution closer to a spectral reflectance distribution of the toner image subjected to detection of an amount of toner contained.

Specifically, in the spectrum of from 400 nm to 700 nm, the reference board 56 as a calibration board has a spectral reflectance distribution that includes a reflectance of 70% of a difference between a maximum reflectance and a minimum reflectance of the reference board 56 when the reference board 56 is irradiated with light having a wavelength of ±20 nm of the wavelength of light that produces a reflectance of 70% of the difference between the maximum reflectance and the minimum reflectance of the toner image. The toner image is a solid toner image fixed on the white recording medium. The spectral reflectance distribution of the toner image is used for obtaining the wavelength of light that produces the reflectance of 70% of the difference between the maximum reflectance and the minimum reflectance of the toner image.

A detailed description is given of how to obtain the wavelengths with the reflectance of 70% of the difference between the maximum reflectance and the minimum reflectance of the cyan, magenta, and yellow toner images.

As illustrated in FIGS. 9 and 18, in the spectrum of from 400 nm to 700 nm, the cyan toner image represented by “CT” has the maximum reflectance of about 70% when light having a wavelength of about 460 nm is incident on the surface of the cyan toner image. On the other hand, the cyan toner image has the minimum reflectance of about 5% when light having a wavelength not less than about 600 nm incident on the surface of the cyan toner image. Accordingly, the cyan toner image has a difference of about 65% between the maximum reflectance of about 70% and the minimum reflectance of about 5%. 70% of the difference (i.e., about 65%) is about 45. 5%.

As illustrated in the spectral reflectance distribution of the cyan toner image represented by “CT” in FIGS. 9 and 18, the cyan toner image has a reflectance of about 45.5% when light of a wavelength of about 420 nm and light of a wavelength of about 510 nm are incident on the surface of the cyan toner image. In other words, about 420 nm and about 510 nm are the wavelengths of light that produces the reflectance of 70% of the difference between the maximum reflectance and the minimum reflectance of the cyan toner image.

Similarly, based on the spectral reflectance distribution of the cyan reference board 56C represented by “CR” in FIG. 18, the spectra or wavelengths of light are obtained that produces a reflectance of 70% of the difference between the maximum reflectance and the minimum reflectance of the cyan reference board 56C. Specifically, the spectra thus obtained are a spectrum of about 420±20 nm and a spectrum of about 510±20 nm.

With regard to the magenta toner image and magenta reference board 56M, light having a wavelength of about 610 nm produces a reflectance of 70% of the difference between the maximum reflectance and the minimum reflectance of the magenta toner image. Light in a spectrum of about 610±20 nm produces a reflectance of 70% of the difference between the maximum reflectance and the minimum reflectance of the magenta reference board 56M.

With regard to the yellow toner image and the reference board 56Y, light having a wavelength of about 510 nm produces a reflectance of 70% of the difference between the maximum reflectance and the minimum reflectance of the yellow toner image. Light in a spectrum of about 510±20 nm produces a reflectance of 70% of the difference between the maximum reflectance and the minimum reflectance of the yellow reference board 56Y.

In the present embodiment, detected data of a toner image is corrected to detect an accurate amount of toner contained in the toner image, based on the detected data of the reference board 56 having a spectral reflectance distribution close to the spectral reflectance distribution of the toner image. Therefore, compared to correction by use of the white reference board alone, the correction according to the present embodiment takes into account the variation in the spectral distributions of the LEDs or in the spectral sensitivity distributions of the image sensors 52a that may affect the detected amount of light reflected from the toner image. The amount of toner contained in the toner image is calculated based on the corrected data. Therefore, compared to typical density sensors that incorporates the white reference board, the density sensor 50 of the present embodiment prevents detection error of toner amount that may be caused by the variation in the spectral distributions of the light emitting devices of the light source 51 or in the spectral sensitivity distributions of the image sensors 52a as light receiving devices. The detected data of the reference board 56 described above is output data of each of the image sensors 52a of the line sensor 52 receiving light emitted by the light source 51 and reflected from the reference board 56. As described above, the detected data of the reference board 56 is used as reference data. The detected data of the toner image described above is output data of each of the image sensors 52a of the line sensor 52 receiving light emitted by the light source 51 and reflected from the toner image such as the test toner image Ta formed on the intermediate transfer belt 31.

Referring now to FIG. 19, a description is given of calculation of an amount of toner contained in the cyan toner image.

FIG. 19 is a flowchart of a process of calculating the amount of toner contained in the cyan test toner image TaC.

In step S21, the line sensor 52 detects the cyan reference board 56C. The storage unit 150 of the controller 15 stores an output of each of the image sensors 52a. For detection of the cyan reference board 56C, the shutter 55 is moved such that the cyan reference board 56C faces the opening of the housing 58, and therefore faces the transparency 54. The light source 51 irradiates the surface of the cyan reference board 56C with the blue light. The line sensor 52 detects the light reflected from the surface of the cyan reference board 56C. Thereafter, the shutter 55 is moved to a position where the shutter 55 does not face the opening of the housing 58 or the transparency 54. Alternatively, the magenta and yellow reference boards 56M and 56Y may be detected after the cyan reference board 56C. Then, the shutter 55 may be moved to the position where the shutter 55 does not face the opening of the housing 58 or the transparency 54.

In step S22, the cyan test toner image TaC (i.e., toner pattern) is formed on the outer circumferential surface of the intermediate transfer belt 31. The line sensor 52 detects the cyan test toner image TaC. The storage unit 150 of the controller 15 stores an output of each of the image sensors 52a (i.e., toner pattern output).

In step S23, the output of each of the image sensors 52a upon detection of the cyan test toner image TaC (i.e., the toner pattern output) is corrected based on the stored output of each of the image sensors 52a upon detection of the cyan reference board 56C as a reference.

In step S24, an amount of toner contained in the cyan test toner image TaC is calculated for each detection area of the image sensors 52a, based on the toner pattern output thus corrected (i.e., corrected toner pattern output).

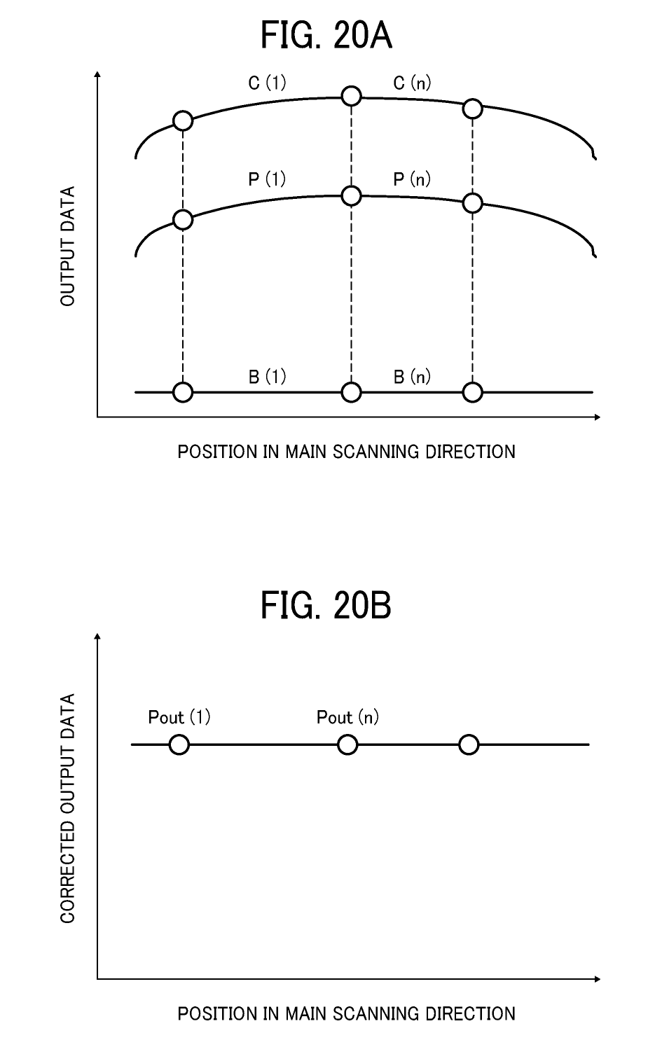

FIGS. 20A and 20B illustrate a shading correction of correcting detected data of the cyan test toner image TaC based on detected data of the cyan reference board 56C.

In FIGS. 20A and 20B, the horizontal axis indicates the position of the image sensors 52a in the main scanning direction. FIG. 20A is a graph illustrating a relationship between the output data of the image sensors 52a and the position of the image sensor 52a in the main scanning direction. A bracketed “n” represents a number designated to each of the image sensors 52a. “C(n)” represents output data of the image sensors 52a upon detection of the cyan reference board 56C. “P(n)” represents output data of the image sensors 52a upon detection of the cyan test toner image TaC formed under image forming conditions including developing and writing conditions to contain a uniform amount of toner therewithin. “B(n)” represents output data of the image sensors 52a when the light source 51 is turned off.

Since the cyan reference board 56C has a uniform spectral reflectance distribution throughout an entire area in the main scanning direction, “C(n)” should illustrate even output data of the image sensors 52a. However, as illustrated in FIG. 20A, the output data C(n) illustrates uneven output data of the image sensors 52a due to variation in the amount of light in the width direction B of the intermediate transfer belt 31 parallel to the main scanning direction and in the sensitivity of the image sensors 52a.

Since the cyan test toner image TaC is formed to contain a uniform amount of toner therewithin, a curved line connecting “P(n)” conforms to a curved line connecting “C(n)” in FIG. 20A. If the cyan test toner image TaC contains an uneven amount of toner therewithin, the curved line connecting “P(n)” may not conform to the curved line connecting “C(n)” because the output data P(n) is affected by the image forming conditions in addition to the variation in the amount of light in the width direction B of the intermediate transfer belt 31 and in the sensitivity of the image sensors 52a.

FIG. 20B is a graph illustrating a relationship between corrected output data of the image sensors 52a and the position of the image sensors 52a in the main scanning direction. In FIG. 20B, “Pout(n)” represents corrected data of the output data of the image sensors 52a upon detection of the cyan test toner image TaC. The corrected output data Pout(n) is obtained based on the output data of the image sensors 52a illustrated in FIG. 20A and Equation 2 below:

$$Pout ( n ) = \frac{P ( n ) - B ( n )}{C ( n ) - B ( n )} \times 255. \qquad Equation 2$$

The corrected output data Pout(n) conforms to an actual amount of toner contained in the cyan test toner image TaC, removing influences of the light amount in the main scanning direction and the variation in the image sensors 52a from the output data P(n) upon detection of the cyan test toner image TaC. Since the cyan test toner image TaC is formed to contain a uniform amount of toner therewithin, FIG. 20B illustrates even corrected output data Pout(n). If the cyan test toner image TaC is formed unevenly, the corrected output data Pout(n) may become uneven.

Based on the corrected output data Pout(n) and data stored in the lookup table, the amount of toner contained in the test toner image TaC is calculated for each detection area of the image sensors 52a where each of the image sensors 52a detects reflection light.

When Equation 2 above is used to calculate the corrected output data, the output data C(n) stored in the storage unit 150 is updated for each detection of the cyan reference board 56C. The corrected output data Pout(n) is calculated based on the output data P(n) upon detection of the cyan test toner image TaC following the detection of the cyan reference board 56C, the output data C(n) and B(n) stored in the storage unit 150, and Equation 2 above. With regard to the output data B(n), predetermined data may be stored in the storage unit 150. Alternatively, output data stored in the storage unit 150 may be updated. Specifically, the output data stored in the storage may be replaced with new output data of the image sensors 52a when the light source 51 is turned off before or after detection of the cyan reference board 56C or the cyan test toner image TaC. The image sensors 52a may receive a flare in addition to the light emitted by the light source 51 and reflected from the toner image or the reference board 56. Output data not affected by the flare can be obtained by subtracting the output data B(n) of the image sensors 52a when the light source 51 is turned off from the actual output data C(n) and P(n) of the image sensors 52a when the light source 51 emits light.

The shading correction to calculate the corrected output data Pout(n) of the image sensors 52a is not limited to using Equation 2 above.

Alternatively, for example, experiments may be conducted in advance to determine desired output data of the image sensors 52a upon detection of the cyan reference board 56C having an even spectral reflectance distribution. A lookup table may be prepared including the output data C(n) of the image sensors 52a upon detection of the cyan reference board 56C and correction formula to correct the output data C(n) to be the desired output data.

When the image sensors 52a detect the cyan reference board 56C, the correction formula is calculated for each of the image sensors 52a based on the output data C(n) and the data included in the lookup table. The storage unit 150 stores the correction formula thus calculated.

On the other hand, when the image sensors 52a detect the cyan test toner image TaC, the output data P(n) of the image sensors 52a is inserted into the correction formula stored in the storage unit 150 to calculate the corrected output data Pout(n).

Based on the corrected output data Pout(n) and data stored in the lookup table, the amount of toner contained in the test toner image TaC is calculated for each detection area of the image sensors 52a where each of the image sensors 52a detects reflection light.

When the correction formula described above is used to calculate the corrected output data, the correction formula stored in the storage unit 150 is updated for each detection of the cyan reference board 56C. The corrected output data Pout(n) is calculated based on the output data P(n) upon detection of the cyan test toner image TaC and the correction formula stored in the storage, and Equation 2 above. The output data not affected by the flare can be obtained by subtracting the output data B(n) of the image sensors 52a when the light source 51 is turned off from the actual output data C(n) and P(n) of the image sensors 52a when the light source 51 emits light.

As described above, for detecting the amount of toner contained in the cyan toner image, the output data of the image sensors 52a receiving the light emitted to and reflected from the cyan toner image is corrected by use of the output data of the image sensors 52a receiving the light emitted to and reflected from the cyan reference board 56C.

Accordingly, in the present embodiment, detection error of toner amount is suppressed even if variation in the light-receiving characteristics of the light receiving devices and in the light-emitting characteristics of the light emitting devices causes detection error on the image sensors.

Since the cyan reference board 56C has a uniform spectral reflectance distribution throughout the entire area in the main scanning direction, detection error is prevented on all the image sensors 52a of the line sensor 52. As a consequence, detection error of toner amount is prevented.

In the image forming apparatus 500, based on the toner amount thus calculated, the controller 15 executes a process of adjusting one or more of the image forming conditions so as to correct an amount of toner contained in the defective portion of the toner image where the amount of toner is out of the given range.

Specifically, for example, the emission intensity of the laser beam emitted by the optical writing device 20 is increased or decreased to form an electrostatic latent image on the surface of the photoconductor 1C corresponding to each detection area of the image sensors 52a, so that the cyan test toner image TaC is formed containing a uniform amount of toner therewithin.

For example, as an experiment, a lookup table is prepared including the output data Pout(n) upon detection of the cyan test toner image TaC and the emission intensity of the laser beam to be modified. According to the lookup table, the emission intensity of the laser beam may be modified depending on the output data Pout(n).

Thus, the optical writing device 20 emits a laser beam with an emission intensity adjusted in the main scanning direction to prevent unevenness in density of the toner image that may be caused by positional difference in the main scanning direction within a page.

The processes of detecting density of the cyan toner and preventing unevenness in the density of the cyan toner image are described above as an example. Similar processes are executed for each of the colors magenta, yellow, and black to detect an accurate amount of toner contained in the toner image and prevent unevenness in the density of the toner image.

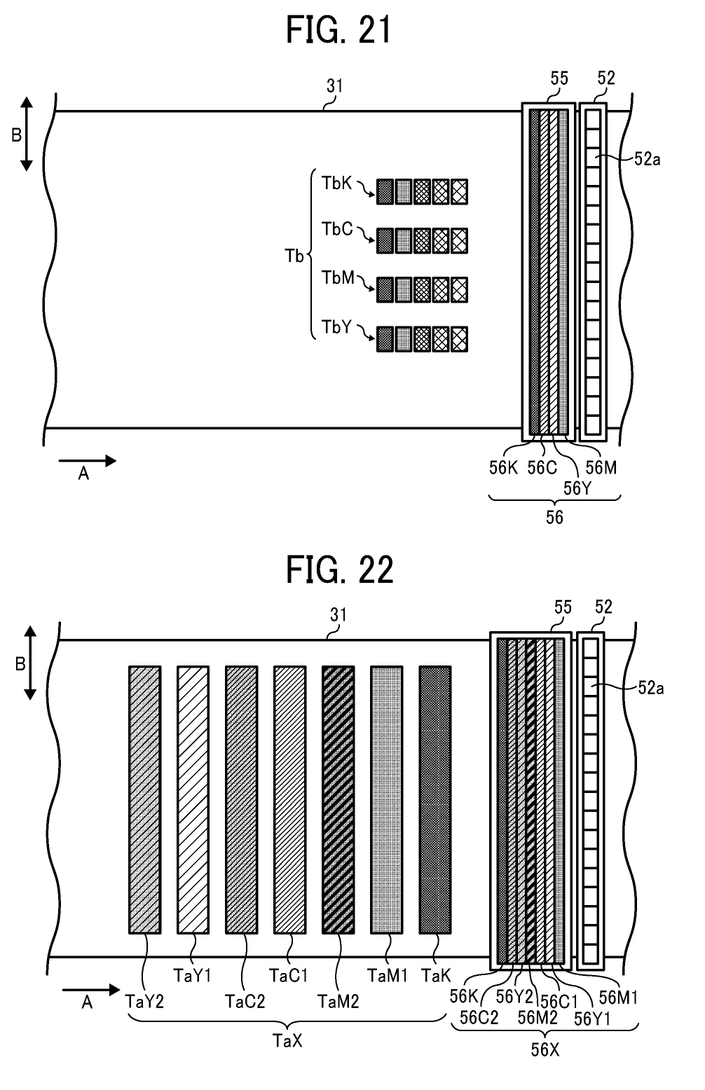

FIG. 21 is a plan view of the line sensor 52, the reference board 56 mounted on the shutter 55, and a gradation pattern toner image Tb formed on the intermediate transfer belt 31, illustrating relative positions thereof.

The gradation pattern toner image Tb is formed on the outer circumferential surface of the intermediate transfer belt 31 based on the process of adjusting the image forming condition (e.g., emission intensity) described above. As illustrated in FIG. 21, the gradation pattern toner image Tb is constructed of black, cyan, magenta, and yellow gradation pattern toner images TbK, TbC, TbM, and TbY. The line sensor 52 detects the gradation pattern toner image Tb for calculation of a developing gamma (γ) and a development starting voltage for each of the image forming devices 10.

Image formation is conducted according to image data read by the scanner 200 or image data input from an external device, by use of the adjusted emission intensity for each position in the main scanning direction together with the developing gamma (γ) and the development starting voltage for each of the image forming devices 10 thus calculated.

Referring now to FIG. 22, a description is given of a variation of the reference board 56 together with a variation of the test toner image Ta.

FIG. 22 is a plan view of the line sensor 52, a reference board 56X as a variation of the reference board 56 mounted on the shutter 55, and a test toner image TaX as a variation of the test toner image Ta formed on the intermediate transfer belt 31, illustrating relative positions thereof.

In the embodiment described above, the reference board 56 includes the four reference boards 56K, 56C, 56M, and 56Y having spectral reflectance distributions corresponding to spectral reflectance distribution of the black, cyan, magenta, and yellow solid toner images, respectively.

On the other hand, the reference board 56X includes seven reference boards.

Specifically, the reference board 56X includes black, magenta, cyan, and yellow reference boards 56K, 56M1, 56C1, and 56Y1 for black, magenta, cyan, and yellow solid test toner images TaK, TaM1, TaC1, and TaY1, respectively. The reference board 56X further includes magenta, cyan, and yellow reference boards 56M2, 56C2, and 56Y2 having spectral reflectance distributions corresponding to spectral reflectance distributions of halftone test toner images TaM2, TaC2, and TaY2, respectively, formed on the outer circumferential surface of the intermediate transfer belt 31. The halftone test toner images TaM2, TaC2, and TaY2 have an even image area rate that is half an image area rate of the solid test toner images TaM1, TaC1, and TaY1, respectively.

Based on the output data of the image sensors 52a upon detection of the black, magenta, cyan, and yellow reference boards 56K, 56M1, 56C1, and 56Y1, the output data of the image sensors 52a upon detection of the solid test toner images TaK, TaM1, TaC1, and TaY1 are corrected. Similarly, based on the output data of the image sensors 52a upon detection of the magenta, cyan, and yellow reference boards 56M2, 56C2, and 56Y2, the output data of the image sensors 52a upon detection of the halftone test toner images TaM2, TaC2, and TaY2 are corrected.

For example, the cyan reference board 56C2 has a spectral reflectance distribution half a spectral reflectance distribution of the cyan reference board 56C1, corresponding to half an amount of toner contained in the cyan test toner image TaC1. The reference board 56X enhances detection of an accurate amount of toner contained in the test toner image TaX.

In the embodiment described above, the output of the image sensors 52a is corrected at one point of the amount of toner corresponding to the cyan reference board 56C. However, different outputs of the image sensors 52a may not be sufficiently corrected if there is a difference in linearity between the amount of toner and the output for each of the image sensors 52a.

For example, if the cyan reference board 56C has a spectral reflectance distribution corresponding to the amount of toner contained in the cyan solid test toner image TaC, different outputs of the image sensors 52a are suppressed in the vicinity of the amount of toner contained in the cyan solid test toner image TaC. By contrast, with respect to an amount of toner contained in a halftone test toner image, different outputs of the image sensors 52a may not be suppressed sufficiently.

Hence, in the density sensor 50 including the reference board 56X, the line sensor 52 detects the magenta, cyan, and yellow reference boards 56M2, 56C2, and 56Y2 corresponding to the amount of toner contained in the magenta, cyan, and yellow halftone test toner images TaM2, TaC2, and TaY2. By use of a plurality of data, the output data of each of the image sensors 52a is corrected to calculate the amount of toner contained in the test toner image, suppressing the different outputs of the image sensors 52a that may be caused by the linearity described above.

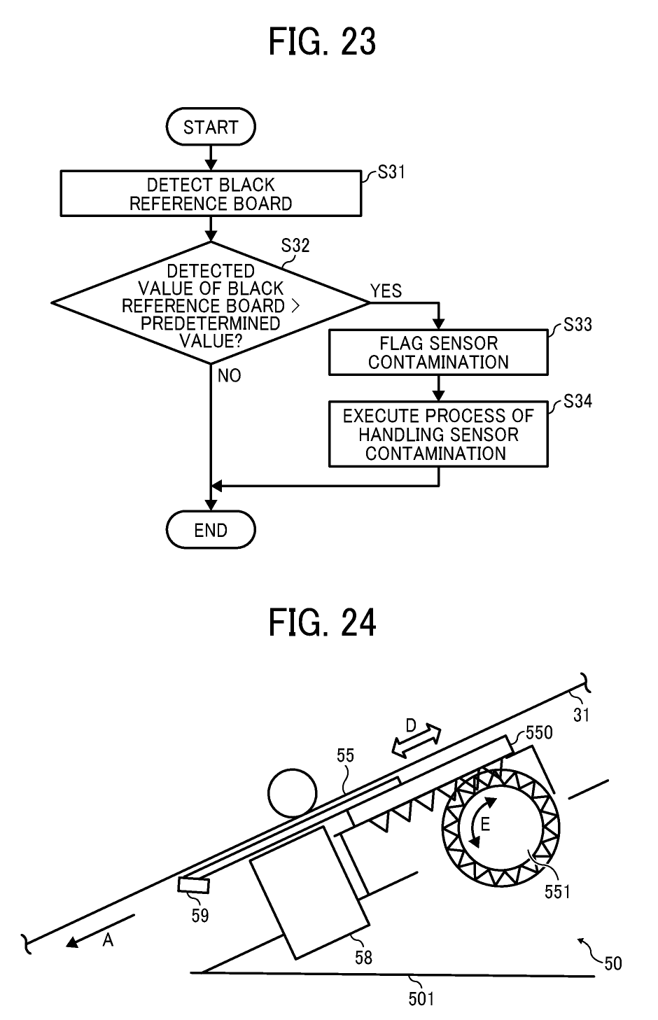

Referring now to FIG. 23, a description is given of detection of contamination in the density sensor 50.

FIG. 23 is a flowchart of a process of identifying contamination in the density sensor 50. FIG. 23 illustrates an example of the process when the transparency 54 is contaminated with foreign matter such as toner. The controller 15 executes the process of FIG. 23 upon detection of the black reference board 56K.

In addition to the cyan, magenta, and yellow reference boards 56C, 56M, and 56Y, the density sensor 50 includes the black reference board 56 having a spectral reflectance distribution corresponding to a spectral reflectance distribution of the black toner image.

By use of data of the black reference board 56K detected by the line sensor 52, the controller 15 identifies contamination in the density sensor 50, in addition to correcting the output data of the image sensors 52a that is used for calculation of the toner amount described above with reference to FIG. 19. In other words, based on the data of the black reference board 56K detected by the line sensor 52, the controller 15 identifies contamination of the transparency 54 and executes a process of handling the contamination.

Specifically, the line sensor 52 of the density sensor 50 is timed to detect the black reference board 56K in step S31. In step S32, output data of each of the image sensors 52a when the line sensor 52 detects the black reference board 56K (herein referred to as detected value of black reference board) is compared to output data for the black reference board 56 predetermined by, e.g., experiments (herein referred to as predetermined value). If the output data of all the image sensors 52a (i.e., detected value of black reference board) is not larger than the predetermined value (No in S32), the process ends.

By contrast, if the output data of one or more of the image sensors 52a (i.e., detected value of black reference board) is larger than the predetermined value (Yes in S32), the controller 15 determines that the transparency 54 is contaminated, and flags sensor contamination in step S33. In step S34, the controller 15 executes the process of handling the sensor contamination.

Specifically, the controller 15 executes one of a process of stopping a detecting operation of the image sensors 52a and a process of cleaning the contaminated surface of the transparency 54 to reduce the detection error of toner amount that may be caused by contamination in the density sensor 50.

Referring now to FIG. 24, a description is given of a cleaning mechanism in the density sensor 50.

FIG. 24 is a schematic view of a cleaning mechanism in the density sensor 50.

The housing 58 of the density sensor 50 is secured on a stay 501 as a sensor supporter provided in the housing of the image forming apparatus 500. On the stay 501 are the shutter 55 and a shutter supporter 550 that supports the shutter 55, separately from the housing 58. Upon detection of the reference board 56, a motor drives and rotates a gear 551 to move the shutter 55 and the reference board 56 mounted on the shutter 55 to a position where the reference board 56 faces the opening of the housing 58.

The gear 551 has teeth that mesh with a line of teeth disposed on the surface of the shutter supporter 550.

As the gear 551 rotates in a clockwise or counterclockwise direction of rotation E, the shutter supporter 550 moves in the direction of movement D along the outer circumferential surface of the intermediate transfer belt 31 as illustrated in FIG. 24. Accordingly, the shutter 55 supported by the shutter supporter 550 and the reference board 56 mounted on the surface of the shutter 55 also move in the direction of movement D.

Thus, the reference board 56 mounted on the surface of the shutter 55 is moved to and from the position where the reference board 56 faces the opening of the housing 58. A sensor cleaner 59 is mounted on an edge of the shutter 55. When contamination of the transparency 54 is identified based on the detected data of the black reference board 56K, the sensor cleaner 59 cleans the surface of the transparency 54. In the present embodiment, the sensor cleaner 59 is a thin-film plastic piece having a thickness of about 100 μm. As the shutter 55 moves, the sensor cleaner 59 scrapes off the surface of the transparency 54 to remove a contaminant such as toner adhering to the surface of the transparency 54.

When the controller 15 executes the cleaning process described above, the shutter 55 reciprocates so that the sensor cleaner 59 also reciprocates on the surface of the transparency 54 to scrape the contaminant from the surface of the transparency 54.

If the light-emitting characteristics of the LEDs of the light source 51 or the light-receiving characteristics of the image sensors 52a do not change over time, detected data of the toner image can be corrected based on the detected data of the reference board 56, reducing the detection error of toner amount that may be caused by the production tolerance of the LEDs or the image sensors 52a.

However, the light-receiving characteristics of the LEDs and the light-receiving characteristics of the image sensors 52a often change as the LEDs and the image sensors 52a deteriorate with time. To correct the detected data of the toner image in association with the changes in characteristics, the reference board 56 is detected at regular intervals.

Further, to detect an accurate amount of toner contained in the test toner image Ta, a preferable frequency of detecting the light reflected from the reference board 56 is the same as a frequency of detecting the test toner image Ta. However, emission of light to the reference board 56 may discolor the magenta, cyan, yellow, and black reference boards 56M, 56C, 56Y, and 56K, causing detection error on the image sensors 52a. In addition, if each of the magenta, cyan, yellow, and black reference boards 56M, 56C, 56Y, and 56K is moved to the position where each of the magenta, cyan, yellow, and black reference boards 56M, 56C, 56Y, and 56K faces the opening of the housing 58 to be irradiated with light from the light source 51 and the output data of the image sensors 52a are obtained before each detection of the test toner image Ta, the controller 15 may be overloaded. On the other hand, the change in the light-emitting characteristics of the LEDs of the light source 51 or in the light-receiving characteristics of the image sensors 52a of the line sensor 52 over time does not suddenly cause fluctuation of the detected data of the reference board 56 in a short period of time.

To address these circumstances, the reference board 56 is detected at predetermined time when it is assumed that the data of the reference board 56 detected by the line sensor 52 fluctuates over time, such as when the power is turned on or when a predetermined period of time elapses. The detected data of the reference board 56 is used for correction of subsequent detected data of the test toner image Ta. Accordingly, an accurate amount of toner contained in the test toner image Ta is detected, suppressing discoloration of the magenta, cyan, yellow, and black reference boards 56M, 56C, 56Y, and 56K and reducing a burden on the controller 15.

However, if the environment in which the density sensor 50 operates (e.g., ambient temperature) changes, the output data of the line sensor 52 upon detection of the reference board 56 may also change even without a noticeable change in the light-emitting characteristics of the LEDs or the light-receiving characteristics of the image sensors 52a over time. In such a case, if the toner image is detected and corrected after the environment changes based on the data of the reference board 56 detected before the environment changes, detection error of toner amount may occur.

As described above, the output of the image sensors 52a upon detection of the reference board 56 depends on the sum of values in the entire spectrum. Each of the values is obtained by “amount of light emitted by LED”×“reflectance of reference board”×“sensitivity of image sensor” for each wavelength.

The output of the image sensors 52a upon detection of the toner image depends on the sum of values in the entire spectrum. Each of the values is obtained by “amount of light emitted by LED”×“reflectance of toner image”×“sensitivity of image sensor” for each wavelength.

Changes in the ambient temperature may change the amount of light emitted by the LEDs of the light source 51 and the spectral distribution, further changing spectral amount of emitted light for each wavelength. Such temperature changes may change, e.g., the optical axis or direction of light emitted by the LEDs and the spectral sensitivity distribution of the image sensors 52a, resulting in changes in the output of the image sensors 52a upon detection of the reference board 56.

To address these circumstances, as illustrated in FIG. 4, the density sensor 50 includes the temperature sensor 57 as an environmental condition detector. The temperature sensor 57 detects an ambient temperature, which is one of the environmental conditions under which the density sensor 50 operates. When the readings of the temperature sensor 57 indicate a predetermined or larger temperature change, the line sensor 52 detects the reference board 56.

As described above with reference to the solid line L1 and the broken lines L2 and L3 of “LeB” in FIGS. 13A and 13B and of “LeR” in FIGS. 14A through 14C, different LEDs may have different spectral distributions.

Even the same LED may have different spectral distributions with different peaks when the ambient temperature changes, as illustrated in the solid line L1 and the broken lines L2 and L3 of “LeB” in FIGS. 13A and 13B and of “LeR” in FIGS. 14A through 14C. Specifically, for example, an LED has a spectral distribution indicated by the solid line L1 of “LeB” or “LeR” at a certain temperature. When the temperature increases, the peak moves to a larger wavelength as indicated by the broken line L2 of “LeB” or “LeR”. By contrast, when the temperature decreases, the peak moves to a smaller wavelength as indicated by the broken line L3 of “LeB” or “LeR”.

As illustrated in FIGS. 13A, 14A, and 14B, each of the cyan, magenta, and yellow toner images has different reflectance depending on the wavelengths. In the vicinity of the peak of the spectral distribution of the emitted light (e.g., blue or red light), the reflectance of the cyan, magenta, and yellow toner images increases as the wavelength increases.

That is, when the toner images containing identical amount of toner are detected at different ambient temperatures, the toner image detected at a higher temperature may have a higher reflectance around the peak of the spectral distribution of the emitted light indicated by the broken line L2. In short, the output of the image sensors 52a increases. By contrast, the toner image detected at a lower temperature may have a lower reflectance around the peak of the spectral distribution of the emitted light indicated by the broken line L3. In short, the output of the image sensors 52a decreases.

As illustrated in FIG. 18, the spectral reflectance distributions of the cyan, magenta, and yellow reference boards 56C, 56M, and 56Y are close to the spectral reflectance distributions of the cyan, magenta, and yellow toner images, respectively. That is, when the reference board 56 having a given spectral reflectance distribution is detected at an increased temperature, the reflectance of the reference board 56 around the peak of the spectral reflectance distribution of the emitted light may increase as the peak moves to a larger wavelength. In short, the output of the image sensors 52a decreases. By contrast, when the reference board 56 is detected at a decreased temperature, the reflectance of the reference board 56 around the peak of the spectral distribution of the emitted light decreases as the peak moves to a smaller wavelength. In short, the output of the image sensors 52a decreases.

Therefore, if the reference board 56 is detected before the temperature changes and the test toner image Ta is detected and corrected after the temperature changes by use of the detected data of the reference board 56, the image sensors 52a may output different data due to the temperature change, hampering detection of an accurate amount of toner contained in the test toner image Ta.

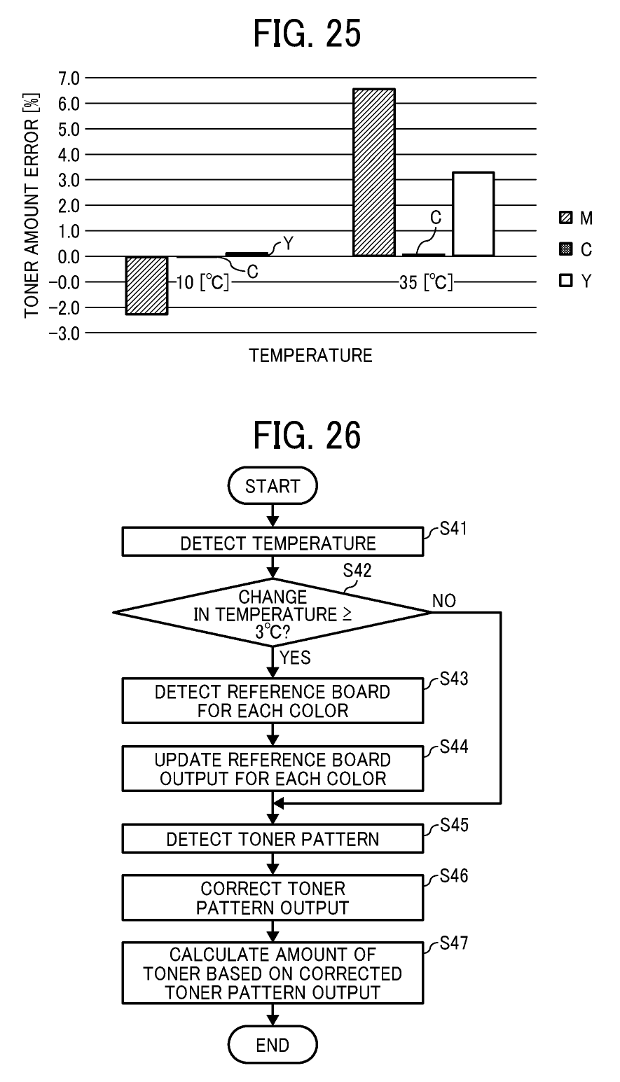

FIG. 25 is a graph illustrating a relationship between detection error of toner amount and temperature. FIG. 25 illustrates the detection error of toner amount caused by temperature changes from a reference temperature of 20° C. to 10° C. or 35° C. Specifically, the reference board 56 is detected for each color at 20° C. The storage unit 150 stores the data of the reference board 56 thus detected. Then, when the temperature changes to 10° C. or 35° C., the test toner image Ta is detected for each color. The detected data of the test toner image Ta is corrected based on the detected data of the reference board 56 thus stored. The amount of toner contained in the test toner image Ta is calculated based on the corrected data. A difference between an actual amount of toner contained in the test toner image Ta and the amount of toner thus calculated is then obtained. The rate of the difference with respect to the actual amount of toner is indicated as “toner amount detection error” in FIG. 25.

For example, when the temperature decreases from 20° C. to 10° C., the amount of magenta toner calculated based on the readings of the density sensor 50 is smaller than the actual amount of toner by 2%.

In the image forming apparatus 500, the controller 15 controls the amount of toner detected by the density sensor 50 to be constant. Therefore, if the test toner image Ta is detected and corrected after the temperature decreases based on the data of the reference board 56 detected before the temperature decreases and the controller 15 controls the amount of toner to be constant, the image density increases as the temperature decreases.

By contrast, if the test toner image Ta is detected and corrected after the temperature increases based on the data of the reference board 56 detected before the temperature increases, a larger amount of toner is calculated than the actual amount of toner. If the controller 15 controls the amount of toner to be constant in this situation, the image density decreases as the temperature increases.

Thus, an even image density is not obtained if the amount of toner is calculated regardless of the temperature change, based on the data of the reference board 56 detected before the temperature changes.

To address these circumstances, in the present embodiment, the density sensor 50 includes the temperature sensor 57 to detect a temperature change. If the temperature sensor 57 detects the predetermined or larger temperature change, the line sensor 52 detects the reference board 56. Thereafter, upon detection of the amount of toner contained in the test toner image Ta, the test toner image Ta is detected and corrected after the temperature changes based on the data of the reference board 56 detected after the temperature changes to calculate the toner density.

The temperature may vary in the width direction B of the intermediate transfer belt 31. To address this circumstance, a plurality of temperature sensors 57 may be disposed in the width direction B of the intermediate transfer belt 31. If one or more of the plurality of temperature sensors 57 detect the predetermined or larger temperature change, the line sensor 52 may detect the reference board 56.

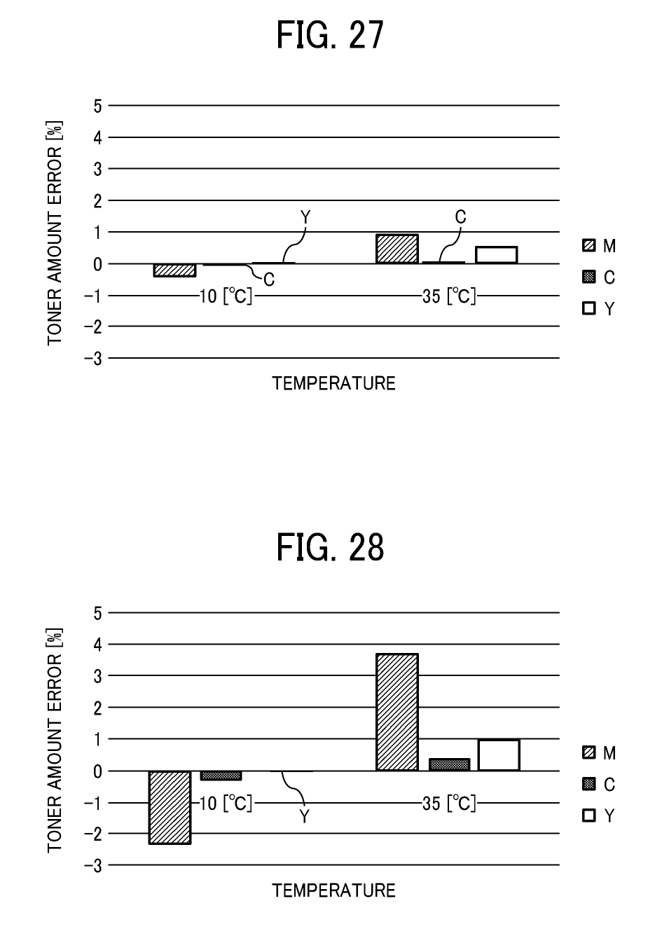

Referring now to FIGS. 26 and 27, a description is given of a first example of detecting the reference board 56 when the predetermined or larger temperature change is detected.

In the first example, the reference board 56 is detected for each color when the temperature sensor 57 detects a temperature change of 3° C. or larger after a previous detection of the reference board 56 for each color. Subsequently, the detected data of the reference board 56 stored in the storage unit 150 is updated.

FIG. 26 is a flowchart of a process of calculating an amount of toner contained in the test toner image according to the first example.

As the controller 15 starts for a process of detecting the test toner image Ta (i.e., toner pattern) and the formation of the toner pattern starts, the temperature sensor 57 detects the temperature of the density sensor 50 in step S41.

In step S42, a temperature change from when the reference board 56 is detected last time is calculated. If the temperature changes by not less than 3° C. (Yes in S42), the controller 15 executes a process of detecting the reference board 56 for each color in step S43. The output data of each of the image sensors 52a upon detection of the reference board 56 (herein referred to as reference board output) stored in the storage unit 150 is updated for each color in step S44 to be used for a shading correction in a step later. The storage unit 150 stores the temperature detected by the temperature sensor 57 in step S41 as a latest temperature upon latest detection of the reference board 56.

On the other hand, if the temperature changes by less than 3° C. (No in S42), the controller 15 does not execute the process of detecting the reference board 56 for each color or update the reference board output stored in the storage unit 150.

Then, in step S45, the test toner image Ta (i.e., toner pattern) is detected for each color. In step S46, the controller 15 executes the shading correction of the toner pattern thus detected based on the reference board output stored in the storage unit 150. Based on the output data of the image sensors 52a after the shading correction (i.e., corrected toner pattern output), an amount of toner contained in the test toner image Ta is calculated for each color, for each detection area of the image sensors 52a in step S47.

FIG. 27 is a graph illustrating a relationship between the detection error of toner amount and the temperature in the first example. FIG. 27 illustrates the detection error of toner amount caused by the temperature change from the reference temperature of 20° C. to 10° C. or 35° C. The error illustrated in FIG. 27 is smaller than the error illustrated in FIG. 25.

As the temperature increases, the output of the image sensors 52a increases upon detection of the toner image for each color. Similarly, the output of the image sensors 52a increases upon detection of the reference board 56 having a spectral reflectance distribution close to a spectral reflectance distribution of the toner image for each color. Therefore, the reference board 56 is detected in response to a given temperature change to update the detected data of the reference board 56 stored in the storage unit 150. Since the shading correction is executed based on the updated data, constant data of the toner image is obtained regardless of the temperature change. That is, even when the temperature changes, the density sensor 50 reduces detection error of toner amount and suppresses fluctuation of image density.

By contrast, use of the white reference board instead of the reference board 56 corresponding to each color of the toner images does not prevent the fluctuation of image density that may be caused by temperature changes.

FIG. 28 is a graph illustrating a relationship between the detection error of toner amount and the temperature when the white reference board is used.

Specifically, FIG. 28 illustrates the detection error of toner amount when the temperature changes from the reference temperature of 20° C. to 10° C. or 35° C. In this case, the white reference board is detected for each temperature change of 3° C.

FIG. 28 illustrates the error substantially the same as the error illustrated in FIG. 25. In other words, when the white reference boards is used, the detection error of toner amount is not reduced.

As illustrated in FIGS. 13B and 14C, the reflectance of the white reference board is substantially the same throughout the visible spectrum. Therefore, even when the temperature increases and the peak of the spectral distribution of the emitted light moves to a larger wavelength, the reflectance of the white reference board around the peak does not change. That is, the output of the image sensors 52a does not change. On the other hand, the output of the image sensors 52a upon detection of the toner image increases as the temperature increases. Therefore, the output data corrected based on the detected data of the white reference board also increases. Thus, use of the white reference board causes detection error due to the temperature change, hampering detection of an accurate amount of toner contained in the toner image.

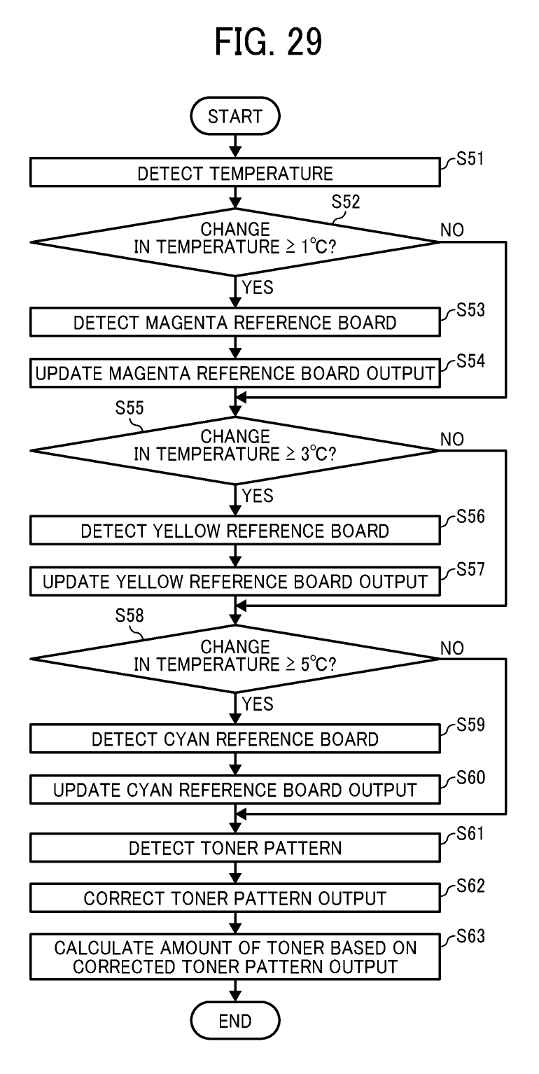

Referring now to FIGS. 29 through 31, a description is given of a second example of detecting the reference board 56 when the predetermined or higher temperature change is detected.

As illustrated in FIGS. 25 and 27, the detection error of the magenta toner amount is larger than the detection error of the cyan and yellow toner amount. By contrast, the detection error of the cyan toner amount is little when the temperature changes.

Accordingly, in the second example, a threshold of temperature change for detecting the reference board 56 is determined for each color. Specifically, the thresholds of temperature change are determined as 1° C., 5° C., and 3° C. for magenta, cyan, and yellow, respectively.

FIG. 29 is a flowchart of the process of calculating an amount of toner contained in the test toner image according to the second example.

As the controller 15 starts for a process of detecting the test toner image Ta and the formation of the test toner image Ta (i.e., toner pattern) starts, the temperature sensor 57 detects the temperature of the density sensor 50 in step S51.

In step S52, a temperature change from when the magenta reference board 56M is detected last time is calculated. If the temperature changes by not less than 1° C. (Yes in S52), the controller 15 executes a process of detecting the magenta reference board 56M in step S53. The output data of each of the image sensors 52a upon detection of the magenta reference board 56M (herein referred to as magenta reference board output) stored in the storage unit 150 is updated in step S54. The storage unit 150 stores the temperature detected by the temperature sensor 57 in step S51 as a latest temperature upon latest detection of the magenta reference board 56M.

On the other hand, if the temperature changes by less than 1° C. (No in S52), the controller 15 does not execute the process of detecting the magenta reference board 56M or update the magenta reference board output stored in the storage unit 150.

In step S55, a temperature change from when the yellow reference board 56Y is detected last time is calculated. If the temperature changes by not less than 3° C. (Yes in S55), the controller 15 executes a process of detecting the yellow reference board 56Y in step S56. The output data of each of the image sensors 52a upon detection of the yellow reference board 56Y (herein referred to as yellow reference board output) stored in the storage unit 150 is updated in step S57. The storage unit 150 stores the temperature detected by the temperature sensor 57 in step S51 as a latest temperature upon latest detection of the yellow reference board 56Y.

On the other hand, if the temperature changes by less than 3° C. (No in S55), the controller 15 does not execute the process of detecting the yellow reference board 56Y or update the yellow reference board output stored in the storage unit 150.

In step S58, a temperature change from when the cyan reference board 56C is detected last time is calculated. If the temperature changes by not less than 5° C. (Yes in S58), the controller 15 executes a process of detecting the cyan reference board 56C in step S59. The output data of each of the image sensors 52a upon detection of the cyan reference board 56C (herein referred to as cyan reference board output) stored in the storage unit 150 is updated in step S60. The storage unit 150 stores the temperature detected by the temperature sensor 57 in step S51 as a latest temperature upon latest detection of the cyan reference board 56C.

On the other hand, if the temperature changes by less than 5° C. (No in S58), the controller 15 does not execute the process of detecting the cyan reference board 56C or update the cyan reference board output stored in the storage unit 150.

In step S61, the test toner image Ta (i.e., toner pattern) is detected for each color. In step S62, the controller 15 executes a shading correction of the toner pattern thus detected based on the magenta, yellow, and cyan reference board outputs stored in the storage. Based on the output data of the image sensors 52a after the shading correction (i.e., corrected toner pattern output), an amount of toner contained in the test toner image Ta is calculated for each detection area of the image sensors 52a in step S63.

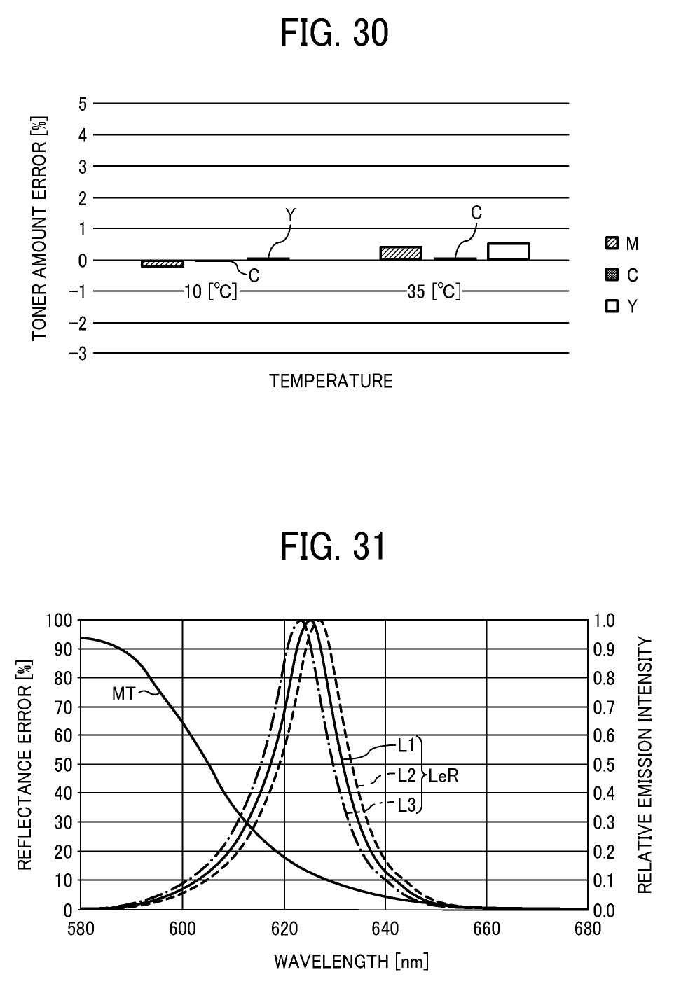

FIG. 30 is a graph illustrating a relationship between the detection error of toner amount and the temperature in the second example of detecting the magenta, yellow, and cyan reference boards, 56M 56Y, and 56C when the temperature changes by the thresholds of 1° C., 3° C., and 5° C., respectively. FIG. 30 illustrates the detection error of toner amount caused by the temperature change from the reference temperature of 20° C. to 10° C. or 35° C. FIG. 30 illustrates a smaller detection error of the magenta toner amount than the detection error of the magenta toner amount illustrated in FIG. 27. Although the cyan reference board 56C is detected less frequently in the second example than in the first example described above, the detection error of the cyan toner amount illustrated in FIG. 30 is not larger than the detection error of the cyan toner amount illustrated in FIG. 27.

In the second example, the reference board 56 is detected at an optimum frequency for each color because the threshold of temperature change for detecting the reference board 56 is determined for each color. Accordingly, the detection error of toner amount is reduced and a burden on the controller 15 is also reduced.

Referring back to FIG. 14A, which illustrates the relationship between the spectral distribution of the red LED represented by “LeR” and the spectral reflectance distribution of the magenta toner image, the reflectance of the magenta toner image significantly changes in a spectrum of from 580 nm to 650 nm.

FIG. 31 is a graph illustrating a distribution of reflectance difference of the magenta toner image and the spectral distribution of the red LED.

Specifically, “MT” represents the distribution of the magenta toner, illustrating a reflectance difference between a maximum reflectance of the magenta toner image around a wavelength of 700 nm and reflectance of the magenta toner image in a spectrum of from 580 nm to 680 nm. “LeR” represents the spectral distribution of the red LED.

As indicated by the solid line L1, the peak of the spectral distribution of the red LED is in the vicinity of a wavelength of 625 nm, where the reflectance of the magenta toner image is decreased by about 13% from the maximum reflectance of the magenta toner image.

General red LEDs have a peak of spectral distribution in a spectrum where the reflectance of the magenta toner image is lower than the maximum reflectance of the magenta toner image by not less than 10%, that is, the reflectance of the magenta toner image is not larger than 90% of the maximum reflectance of the magenta toner image. Incorporation of such general red LEDs in the density sensor 50 reduces the production cost.

However, when the peak of the spectral distribution of the general red LEDs fluctuates due to the temperature change, the reflectance of the magenta toner image fluctuates significantly in the spectrum around the peak of spectral distribution of the general red LEDs. In such a case, the output of the image sensors 52a receiving the reflection light also fluctuates and may cause detection error of toner amount or density.

By contrast, if a red LED has a peak of spectral distribution in a spectrum of e.g., 660 nm or higher, where the reflectance of the magenta toner image is close to the maximum reflectance of the magenta toner image, the temperature change may not cause the detection error of toner amount or density. Even if the peak of the spectral distribution of the red LED fluctuates due to the temperature change, the reflectance of the magenta toner image hardly fluctuates in the spectrum around the peak of the spectral distribution of the red LED. Therefore, the amount of reflection light and the output of the image sensors 52a hardly fluctuate due to the temperature change.

If such a red LED is not used widely, having a peak of spectral distribution in the spectrum where the reflectance of the magenta toner image hardly fluctuates due to the temperature change, use of such an LED as the light source 51 may increase the production cost.

As described above, in the present embodiment, the reference board 56 having a spectral reflectance distribution close to the spectral reflectance distribution of the toner image is detected in response to a given temperature change. Based on the data of the reference board 56 thus detected, the detected data of the toner image is corrected.

Specifically, when the peak of the spectral distribution of the LED fluctuates due to the temperature change and the reflectance of the magenta toner image also fluctuates in the spectrum around the peak of the spectral distribution of the LED, the magenta reference board 56M is detected that has a reflectance fluctuating in the spectrum around the peak of the spectral distribution of the LED, similar to the reflectance of the magenta toner image. Based on the data of the magenta reference board 56M thus detected, the detected data of the magenta toner image is corrected.

Accordingly, even if the reflectance of the magenta toner image fluctuates significantly in the spectrum around the peak of the spectral distribution of the LED, the output of the image sensors 52a hardly fluctuate. As a consequence, detection error of toner amount or density is reduced.

In other words, although the reflectance of the magenta toner image fluctuates significantly in the spectrum around the peak of the spectral distribution of the general red LEDs, use of the general red LEDs does not hamper reduction of the detection error of toner amount or density. That is, in the present embodiment, the spectrum where the peak of the spectral distribution of the LED varies may be the spectrum where the reflectance of the magenta toner image is lower than the maximum reflectance of the magenta toner image by not less than 10%.

Since an accurate amount of toner can be detected by use of the general LEDs in the present embodiment, the production cost is reduced compared to a density sensor that incorporates an LED having a peak of spectral distribution in the spectrum where the reflectance of the magenta toner image hardly changes.

The detection of temperature illustrated in FIGS. 26 and 29 is preferably conducted when a temperature change is forecast. For example, when the power of the image forming apparatus 500 is turned on or when the temperature detected by, e.g., fixing device 38 that constantly detects temperature significantly changes, the temperature may be detected as in step S41 of FIG. 26 and in step S51 of FIG. 29. The temperature may be detected for each printing of a predetermined number of recording media. The temperature may be detected for each detection of the amount of toner contained in the toner image.

When the controller 15 determines that the temperature is to be detected, the process of FIG. 26 or 29 starts.

When the temperature changes, overall light-emitting characteristics of the LEDs change in the light source 51 and overall light-receiving characteristics of the image sensors 52a change in the line sensor 52. When the overall light-emitting characteristics and light-receiving characteristics change, the shading correction may be insufficient to reduce the detection error of toner amount.

Therefore, when the reference board 56 is detected in response to a given the temperature change, the controller 15 may execute an output adjustment process to adjust the amount of light emitted from the light source 51 and/or the light sensitivity of the image sensors 52a (i.e., strength of electrical signals with respect to the light amount) based on the detected data of the reference board 56.

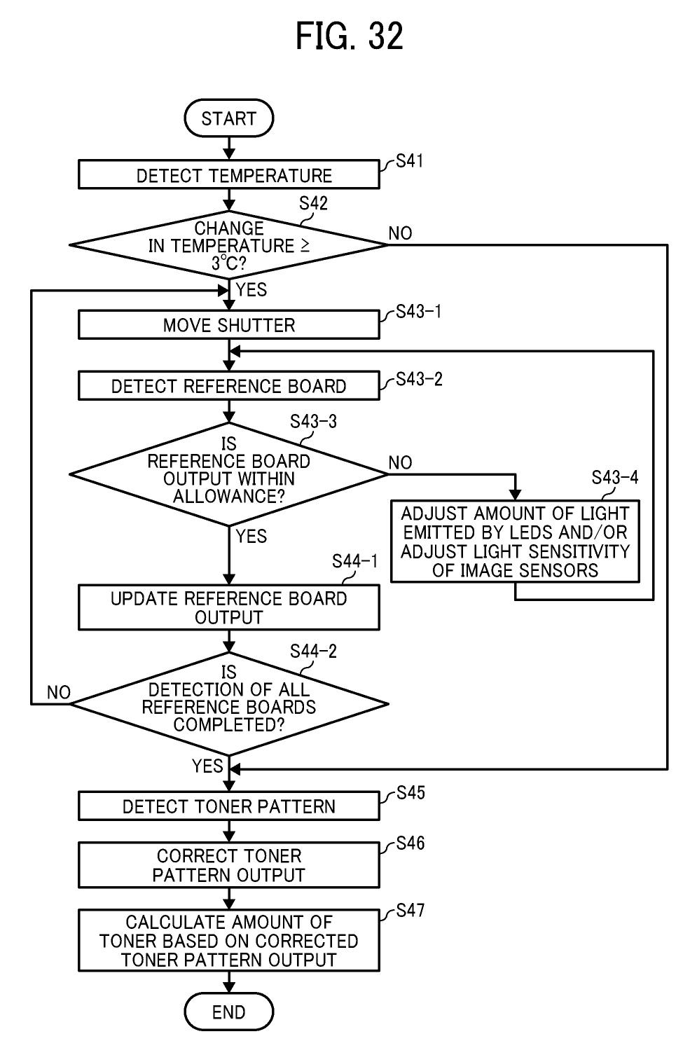

Referring now to FIG. 32, a description is given of the output adjustment process.

FIG. 32 is a flowchart of the process of FIG. 26 combined with an output adjustment process. Specifically, the output adjustment process is applied to the process between steps S42 and S45. Steps S41, S46, and S47 remain unchanged.

In step S42, the temperature change from when the reference board 56 is detected last time is calculated. If the temperature changes by not less than 3° C. (Yes in S42), the reference board 56 is detected for each color. Optionally, the controller 15 may execute the output adjustment process to adjust the output of the LEDs and/or the image sensors 52a. The storage unit 150 stores the temperature detected by the temperature sensor 57 in step S41 as a latest temperature upon latest detection of the reference board 56.

The output adjustment process starts with moving the shutter 55 such that a first reference board 56 (e.g., cyan reference board 56C) faces the opening of the housing 58 in step S43-1. In steps S43-2, the first reference board 56 facing the opening of the housing 58 is detected. In step S43-3, the controller 15 determines whether the output of the image sensors 52a (i.e., reference board output) is within a predetermined allowance of a desired output. If the controller 15 determines that the reference board output is not within the allowance (No in S43-3), the controller 15 increases or decreases the amount of light emitted by the LEDs and/or increases or decreases the light sensitivity of the image sensors 52a so that the reference board output is within the allowance in step S43-4. Then, the process returns to step S43-2 to detect the reference board 56 again.

By contrast, if the controller 15 determines that the reference board output is within the allowance (Yes in S43-3), the output data of each of the image sensors 52a upon detection of the reference board 56 (i.e., reference board output) stored in the storage unit 150 is updated in step S44-1. In step S44-2, the controller 15 determines whether all the colors of reference board 56 are detected. If the controller 15 determines that not all the colors of reference board 56 are detected (No in S44-2), the process returns to step S43-1. For example, if only the first reference board 56 (e.g., cyan reference board 56C) is detected, then the controller 15 moves the shutter 55 again so that a second reference board 56 (e.g., yellow reference board 56Y) faces the opening of the housing 58 in step S43-1. By contrast, if the controller 15 determines that all the colors of reference board 56 are detected (Yes in S44-2), then the controller 15 completes the output adjustment process. In steps S45, the test toner image Ta (i.e., toner pattern) is detected for each color. The process following step S45 is the same as the process illustrated in FIG. 26.

Since the duration of the output adjustment process is not constant, formation of the test toner image Ta (i.e., toner pattern) does not start before the temperature is detected. After the output adjustment process is completed, the test toner image Ta (i.e., toner pattern) is formed and detected in step S45.

If the temperature changes by less than 3° C. (No in step S42), the process goes to step S45. That is, the controller 15 does not execute the output adjustment process. In step S45, the toner pattern is formed and detected.

In the present example, the controller 15 executes the output adjustment process when the temperature changes by not less than 3° C. The threshold of temperature change (e.g., 3° C.) for executing the output adjustment process is determined by, e.g., experiments made to examine variation in the outputs of the LEDs of the light source 51 and the image sensors 52a caused by the temperature change.

Generally, the amount of light emitted by the individual LEDs is not separately adjusted. Similarly, the light sensitivity of the individual image sensors 52a is not separately adjusted. However, if the amount of light emitted by all the LEDs or the light sensitivity of all the image sensors 52a is adjusted simultaneously, the controller 15 calculates an average of output data of all the image sensors 52a (i.e., reference board output) to determine whether the average output is within the predetermined allowance of the desired output. The controller 15 adjusts the amount of light emitted by all the LEDs or the light sensitivity of all the image sensors 52a so that the average output of the image sensors 52a is within the allowance.

Alternatively, the amount of light emitted by the LEDs may be adjusted for each group of adjacent LEDs. In such a case, the controller 15 calculates an average of output data of the image sensors 52a receiving the light emitted by the group of adjacent LEDs and reflected from the reference board 56. Then, the controller 15 determines whether the average output is within the predetermined allowance of the desired output. The controller 15 adjusts the amount of emitted light for each group of adjacent LEDs so that the average output of the image sensors 52a is within the allowance.

Alternatively, the light sensitivity of the individual image sensors 52a may be separately adjusted. In such a case, the controller 15 determines whether the output data of each of the image sensors 52a (i.e., reference board output) is within the predetermined allowance of the desired output. The controller 15 adjusts the light sensitivity of each of the image sensors 52a so that the output data of each of the image sensors 52a is within the allowance.

Generally, there are fewer LEDs of the light source 51 than the image sensors 52a of the line sensor 52. However, if the density sensor 50 includes the LEDs as much as the image sensors 52a and if the LEDs that emits light are paired with the image sensors 52a that receives reflection light from the LEDs, the amount of light emitted by the individual LEDs may be separately adjusted. In such a case, the controller 15 determines whether the output data of each of the image sensors 52a is within the predetermined allowance of the desired output. The controller 15 adjusts the amount of light emitted by each of the LEDs so that the output data of each of the image sensors 52a is within the allowance.

As described above, the light sensitivity of the individual image sensors 52a may be separately adjusted. In such a case, the controller 15 may adjust the light sensitivity of each of the image sensors 52a so that the output data of each of the image sensors 52a upon detection of the reference board 56 becomes a predetermined output value, as a correction of detecting conditions of the amount of toner, instead of the shading correction described above. After the light sensitivity is adjusted, the image sensors 52a detect the test toner image Ta. The controller 15 calculates the amount of toner contained in the test toner image Ta based on the readings of the image sensors 52a. Accordingly, an accurate amount of toner contained in the test toner image Ta is detected.

As described above, if the density sensor 50 includes the LEDs as much as the image sensors 52a and if the LEDs that emits light are paired with the image sensors 52a that receives reflection light from the LEDs, the amount of light emitted by the individual LEDs may be separately adjusted. In such a case, the controller 15 may adjust the amount of light emitted by each of the LEDs paired with each of the image sensors 52a so that the output data of each of the image sensors 52a upon detection of the reference board 56 becomes the predetermined output value, as a correction of detecting conditions of the amount of toner, instead of the shading correction described above. After the amount of light emitted by each of the LEDs is adjusted, the light source 51 emits light and the image sensors 52a detect the test toner image Ta. The controller 15 calculates the amount of toner contained in the test toner image Ta based on the readings of the image sensors 52a. Accordingly, an accurate amount of toner contained in the test toner image Ta is detected.

As described above, in the present embodiment, an image (e.g., toner image) is formed on the intermediate transfer belt 31. The density sensor 50 detects the density of the image formed on the intermediate transfer belt 31. Thus, the intermediate transfer belt 31 serves as an image bearer on which the image is formed and detected by the image density detector. Alternatively, the image bearer may be a recording medium, the conveyor belt 36 as a transfer conveyor belt, or the photoconductor 1 as a latent image bearer. In other words, the image may be formed on the recording medium, the conveyor belt 36, or the photoconductor 1, and detected by the density sensor 50.

As described above, in the present embodiment, the density sensor 50 includes the reference board 56 that is constituted of the cyan, magenta, yellow, and black reference boards 56C, 56M, 56Y, and 56K. The cyan, magenta, yellow, and black reference boards 56C, 56M, 56Y, and 56K have a spectral reflectance distribution identical or close to the spectral reflectance distribution of the cyan, magenta, yellow, and black toner, respectively, to form the test toner image Ta. The density sensor 50 detects the image density of the test toner image Ta for image density adjustment.

Preferably, the reference board 56 has exactly the same color or spectral reflectance distribution as the color or spectral reflectance distribution of the toner. Alternatively, however, the spectral reflectance distribution of the reference board 56 may approximate the spectral reflectance distribution of the toner as illustrated in FIG. 18. For example, the cyan reference board 56C preferably has exactly the same spectral reflectance distribution as the spectral reflectance distribution of the cyan toner. Alternatively, however, the spectral reflectance distribution of the cyan reference board 56C may approximate the spectral reflectance distribution of the cyan toner.

A spectrocolorimeter may be used to measure the spectral reflectance distribution of the reference board 56 and the toner image. In such a case, the spectral reflectance distribution of the reference board 56 thus measured approximates the spectral reflectance distribution of the toner image thus measured.

In the present embodiment, as illustrated in FIG. 18, the spectral reflectance distributions of the cyan, magenta, and yellow reference boards 56C, 56M, and 56Y approximate the cyan, magenta, and yellow toner images, respectively, in an entire visible spectrum of wavelengths from 400 nm to 700 nm.

The reference board 56 is not limited to the reference board having a spectral reflectance distribution that approximates the spectral reflectance distribution of the toner image in the entire visible spectrum. Alternatively, the reference board 56 may have a spectral reflectance distribution that approximates the spectral reflectance distribution of the toner image in a spectrum of light emitted to the toner image or in a spectrum of light passing the filters mounted on the image sensors 52a upon detection of the toner image.

That is, the spectral reflectance distribution of the reference board 56 may approximates the spectral reflectance distribution of the toner image when the red or blue light is emitted.

Specifically, for example, if the blue light is emitted to the cyan toner image and an amount of light reflected from the cyan toner is measured, the color of the reference board 56 irradiated with the blue light has a spectral reflectance distribution that approximates the spectral reflectance distribution of the cyan toner. That is, even if the reference board 56 is irradiated with white light and does not look cyan, that is, the spectral reflectance distribution of the reference board 56 irradiated with the white light does not approximate the spectral reflectance distribution of the cyan toner, the spectral reflectance distribution of the reference board 56 may approximate the spectral reflectance distribution of the cyan toner in a spectrum of the blue light emitted. For example, when the white light is emitted to a reference board of cyan mixed with magenta, the color of the reference board is different from cyan. That is, the spectral reflectance distribution of the reference board does not approximate the spectral reflectance distribution of the cyan toner. By contrast, when the blue light that rarely includes light of a wavelength of 580 nm or larger is emitted to the reference board, the color of the reference board gets close to cyan. That is, the spectral reflectance distribution of the reference board approximates the spectral reflectance distribution of the cyan toner.

If the image sensors 52a are provided with the red, green, and blue filters and the white light is emitted, the similar results are obtained.

In the present embodiment, the image forming apparatus 500 as a copier incorporates the image density detector 50U including the density sensor 50. Alternatively, the image density detector 50U may be incorporated in an examination device that examines whether an image formed on a recording medium has unevenness in density.

Although specific embodiments and examples are described, the embodiments and examples according to the present disclosure are not limited to those specifically described herein. The embodiments and examples attain advantages below in a plurality of aspects A through Q.

A description is now given of advantages in an aspect A of the present disclosure.

An image density detector (e.g., image density detector 50U) for detecting image density of an image borne by an image bearer includes a reference board (e.g., reference board 56), a light emitter (e.g., light source 51), a light receiver (e.g., line sensor 52), an image density calculator (e.g., toner amount calculator 153), and an image density detecting condition corrector (e.g., toner pattern output corrector 152). The light emitter emits light to the reference board and the image (e.g., test toner image Ta) borne by the image bearer (e.g., intermediate transfer belt 31). The light receiver receives the light emitted by the light emitter and reflected from the image and the reference board. The image density calculator calculates the image density of the image (e.g., amount of toner contained in the test toner image Ta) based on an output of the light receiver receiving the light reflected from the image (e.g., toner pattern output). The image density detecting condition corrector corrects a detecting condition of the image density or an image density detecting condition (e.g., toner pattern output used for detection of image density) based on an output of the light receiver receiving the light reflected from the reference board (e.g., reference board output). The reference board has a spectral reflectance distribution closer to a spectral reflectance distribution of the image forming material than a spectral reflectance distribution of white.

Accordingly, the image density detecting condition is corrected as appropriate to detect an accurate image density, compared to a comparative image density detector that uses a white reference board to detect image density.

Specifically, in the comparative image density detector, variation in light-receiving characteristics of the light receiver or in light-emitting characteristics of the light emitter may hamper appropriate correction of the image density detecting condition based on the output of the light receiver receiving the light reflected from the reference board.

This is because the toner image and the white reference board have significantly different spectral reflectance distributions. The variation in light-emitting characteristics of the light emitter or in light-receiving characteristics of the light receiver may affect detected image density on the one hand, such variation may not affect detected light reflected from the white reference board on the other hand. Therefore, in the comparative image density detector, the image density detecting condition is not appropriately corrected taking into account the influences of the variation described above.

By contrast, in the aspect A, the image density detector includes the reference board having a spectral reflectance distribution that approximates the spectral reflectance distribution of the image forming material, so as to appropriately correct the image density detecting condition taking into account the influences of the variation in light-emitting characteristics of the light emitter or in light-receiving characteristics of the light receiver. Accordingly, in the image density detector according to the aspect A, the image density detecting condition is corrected as appropriate to detect an accurate image density, compared to the comparative image density detector that incorporates the white reference board.

A description is now given of advantages in an aspect B of the present disclosure.

In the aspect A, the reference board (e.g., reference board 56) includes a plurality of reference boards (e.g., cyan reference board 56C, magenta reference board 56M, and yellow reference board 56Y). The plurality of reference boards differ from each other in spectral reflectance distribution. The plurality of reference boards is selectively used to correct the image density detecting condition (e.g., toner pattern output used for detection of image density) depending on the spectral reflectance distribution of the image forming material (e.g., toner).

Accordingly, the image density detecting condition is corrected as appropriate to detect an accurate image density, compared to the comparative image density detector that incorporates the white reference board.

Specifically, one of the plurality of reference boards is selected that has a spectral reflectance distribution identical or closer to the spectral reflectance distribution of the image forming material contained in the image of which the image density is detected, than the rest of the plurality of reference boards. The image density detecting condition is corrected based on the output of the light receiver receiving the light reflected from the reference board thus selected. Thus, the image density detecting condition is corrected taking into account the influences of the variation in light-emitting characteristics of the light emitter and/or in light-receiving characteristics of the light receiver. Since the reference board and the image forming material have identical or similar spectral reflectance distributions, the image density detecting condition is corrected as appropriate. Accordingly, in the image density detector according to the aspect B, the image density detecting condition is corrected as appropriate to detect an accurate image density, compared to the comparative image density detector that incorporates the white reference board.

A description is now given of advantages in an aspect C of the present disclosure.

In the aspect A or B, the image density detector (e.g., image density detector 50U) further includes an environmental condition detector (e.g., temperature sensor 57). The environmental condition detector detects an environmental condition (e.g., ambient temperature) under which the image density detector operates. In response to a predetermined or larger change in the environmental condition detected by the environmental condition detector, the light emitter (e.g., light source 51) emits light to the reference board (e.g., reference board 56). The light receiver (e.g., line sensor 52) receives the light emitted by the light emitter and reflected from the reference board.

Accordingly, the image density detecting condition after the environmental change is corrected based on the output of the light receiver receiving the light reflected from the reference board (e.g., reference board output) after the temperature change. Therefore, even when the light-emitting characteristics of the light emitter or the light-receiving characteristics of the light receiver change due to the environmental change, the image density detecting condition is corrected as appropriate to detect an accurate image density.

If the environmental condition detector detects a change in the environmental condition less than the predetermined change, the light emitter does not irradiate the reference board with light, and therefore, the light receiver does not output data, reducing a burden on a controller (e.g., controller 15).

A description is now given of advantages in an aspect D of the present disclosure.

In the aspect C, the light emitter (e.g., light source 51) includes a plurality of light emitting devices (e.g., LEDs). A reflectance of the image forming material (e.g., magenta toner) becomes 90% or less of a maximum reflectance of the image forming material in the spectral reflectance distribution of the image forming material in a spectrum around a peak of a spectral distribution of light emitted by at least one of the plurality of light emitting devices.

Accordingly, the image density detecting condition is corrected as appropriate to detect an accurate image density, compared to the comparative image density detector that incorporates the white reference board.

A description is now given of advantages in an aspect E of the present disclosure.

In the aspect C or D, the light emitter (e.g., light source 51) includes a plurality of light emitting devices (e.g., LEDs). The environmental condition detector is a temperature detector (e.g., temperature sensor 57). The predetermined change in the environmental condition detected by the temperature detector is a temperature change determined by temperature characteristics of the plurality of emitting devices (e.g., LEDs).

Accordingly, even if the spectral reflectance distribution of the plurality of emitting devices changes due to the temperature change, an accurate image density (e.g., amount of toner contained in the image) is detected.

A description is now given of advantages in an aspect F of the present disclosure.

In any one of the aspects C through E, the reference board (e.g., reference board 56) includes a plurality of reference boards (e.g., cyan reference board 56C, magenta reference board 56M, and yellow reference board 56Y). The plurality of reference boards differ from each other in spectral reflectance distribution. A plurality of degrees of the predetermined change in the environmental condition triggers detection of the plurality of reference boards, respectively.

Accordingly, as described above in the second example, each of the plurality of reference boards is detected at an optimum frequency. As a consequence, detection error of image density (e.g., amount of toner contained in the image) is suppressed while the burden on the controller is reduced.

Specifically, when the environmental condition (e.g., temperature) changes, the light-emitting characteristics of the light emitter change. For example, the peak of the spectral distribution of the light emitted by the light emitter changes. The influences of such a change in the light-emitting characteristics on detection of the image density depend on the spectral reflectance distribution of the image forming material. Therefore, a threshold (e.g., degree of the predetermined change in the environmental condition) is determined for each of the plurality of reference boards differing from each other in spectral reflectance distribution, so as to detect each of the plurality of reference boards at an optimum frequency.

A description is now given of advantages in an aspect G of the present disclosure.

In the aspect F, the plurality of reference boards (e.g., cyan reference board 56C, magenta reference board 56M, and yellow reference board 56Y) have the spectral reflectance distributions corresponding to spectral reflectance distributions of cyan, magenta, and yellow image forming materials (e.g., toner), respectively. For example, the spectral reflectance distribution of the cyan reference board 56C corresponds to the spectral reflectance distribution of the cyan toner. The degree of the predetermined change in the environmental condition (e.g., threshold of temperature change) for detecting one of the plurality of reference boards (e.g., magenta reference board 56M) having the spectral reflectance distribution corresponding to the spectral reflectance distribution of the magenta image forming material is smaller than the degrees of the predetermined change in the environmental condition for detecting rest of the plurality of reference boards (e.g., cyan reference board 56C and yellow reference board 56Y).

Accordingly, as described above in the second example, detection error of image density (e.g., amount of toner contained in the image) is suppressed while the burden on the controller is reduced.

Specifically, the change in the environmental condition (e.g., temperature) causes a larger detection error of image density of a magenta toner image than detection errors of image density of cyan and yellow toner images. Therefore, the reference board corresponding to the magenta image forming material is detected more frequently than the other reference boards. As a consequence, detection error of image density is suppressed for all the colors while the burden on the controller is reduced.

A description is now given of advantages in an aspect H of the present disclosure.

In any one of the aspects A through G, the image density detector (e.g., image density detector 50U) further includes a black board (e.g., black reference board 56K) having a black surface. The light emitter (e.g., light source 51) emits light to the black board.

Accordingly, foreign matter (e.g., contaminant) can be detected that may be present between the black board and the light emitter or between the black board and the light receiver (e.g., line sensor 52).

A description is now given of advantages in an aspect I of the present disclosure.

In the aspect H, the image density detector (e.g., image density detector 50U) further includes a foreign matter identifier (e.g., foreign matter identifier 155) and a process executer (e.g., process executer 156). The foreign matter identifier determines whether foreign matter (e.g., toner) is present between the black board and the light emitter or between the black board and the light receiver, based on an output of the light receiver (e.g., line sensor 52) receiving the light emitted to the black board (e.g., black reference board 56K). The process executer executes one of a process of not using a partial output of the light receiver (e.g., output of some of the image sensors 52a) receiving light reflected from the foreign matter and a process of removing the foreign matter, in response to determination by the foreign matter identifier that the foreign matter is present.

Accordingly, detection error of image density that may be caused by the foreign matter is reduced.

A description is now given of advantages in an aspect J of the present disclosure.

In any one of the aspects A through I, the image bearer (e.g., intermediate transfer belt 31) rotates relatively to the light receiver (e.g., line sensor 52). The light receiver includes a plurality of light receiving devices (e.g., image sensors 52a) aligned across a width direction of the image bearer (e.g., width direction B, main scanning direction), in a direction perpendicular to a direction of rotation (e.g., direction of rotation A) of the image bearer. The reference board (e.g., reference board 56) has an even spectral reflectance distribution throughout an entire area in which the light receiver receives reflection light in the width direction of the image bearer.

Accordingly, detection error of image density (e.g., amount of toner contained in the image) is suppressed for all the light receiving devices aligned in the width direction of the image bearer. Since an accurate image density is detected throughout the entire light receiving area in the width direction of the image bearer, unevenness in the image density is detected in the width direction of the image bearer. Preferably, the reference board has an even spectral reflectance distribution throughout the entire light receiving area in the width direction of the image bearer. However, any difference caused by production tolerance is allowed.

A description is now given of advantages in an aspect K of the present disclosure.

An image forming apparatus (e.g., image forming apparatus 500) includes an image bearer (e.g., intermediate transfer belt 31), an image forming device (e.g., image forming device 10), the image density detector (e.g., image density detector 50U) according to any one of the aspects A through J, and an image forming condition adjuster (e.g., image forming condition adjuster 154). The image forming device forms an image (e.g., test toner image Ta) with an image forming material (e.g., toner) on a surface of the image bearer. The image density detector detects image density of the image formed on the surface of the image bearer. The image forming condition adjuster adjusts one or more image forming conditions of the image forming device based on the image density detected by the image density detector.

Accordingly, an accurate image density is detected. The controller adjusts one or more image forming conditions based on the image density thus detected by the image density detector. As a consequence, the image forming apparatus outputs an image without unevenness in density.

A description is now given of advantages in an aspect L of the present disclosure.

In the aspect K, the image forming device (e.g., image forming devices 10) includes a cyan image forming device (e.g., image forming device 10C), a yellow image forming device (e.g., image forming device 10Y), and a magenta image forming device (e.g., image forming device 10M). The cyan image forming device forms a cyan image (e.g., test toner image TaC) with a cyan image forming material (e.g., cyan toner). The yellow image forming device forms a yellow image (e.g., test toner image TaY) with a yellow image forming material (e.g., yellow toner). The magenta image forming device forms a magenta image (e.g., test toner image TaM) with a magenta image forming material (e.g., magenta toner). The reference board (e.g., reference board 56) includes a plurality of reference boards (e.g., cyan reference board 56C, yellow reference board 56Y, and magenta reference board 56M). The plurality of reference boards have spectral reflectance distributions corresponding to spectral reflectance distributions of the cyan, yellow, and magenta image forming materials, respectively.

Accordingly, an accurate image density is detected for each of the colors cyan, yellow, and magenta. As a consequence, the image forming apparatus outputs an image without unevenness in density.

A description is now given of advantages in an aspect M of the present disclosure.

In the aspect L, in the spectral reflectance distribution of the cyan image forming material in a spectrum of from 400 nm to 700 nm, a reflectance of the cyan image forming material (e.g., cyan toner) becomes 70% of a difference between a maximum reflectance of the cyan image forming material and a minimum reflectance of the cyan image forming material in spectra of 420±20 nm and 510±20 nm. In the spectral reflectance distribution of the magenta image forming material in the spectrum of from 400 nm to 700 nm, a reflectance of the magenta image forming material (e.g., magenta toner) becomes 70% of a difference between a maximum reflectance of the magenta image forming material and a minimum reflectance of the magenta image forming material in a spectrum of 610±20 nm. In the spectral reflectance distribution of the yellow image forming material in the spectrum of from 400 nm to 700 nm, a reflectance of the yellow image forming material (e.g., yellow toner) becomes 70% of a difference between a maximum reflectance of the yellow image forming material and a minimum reflectance of the yellow image forming material in a spectrum of 510±20 nm.

Accordingly, an accurate image density is detected for each of the colors cyan, yellow, and magenta that satisfy the above described conditions. As a consequence, the image forming apparatus outputs an image without unevenness in density.

A description is now given of advantages in an aspect N of the present disclosure.

In any one of the aspects K through M, the image formed by the image forming device (e.g., image forming device 10) includes a first image (e.g., solid test toner images TaM1, TaC1, and TaY1) and a second image (e.g., halftone test toner images TaM2, TaC2, and TaY2). The first image has a predetermined image area rate. The second image has an image area rate lower than the predetermined image area rate of the first image. The reference board includes a first reference board (e.g., magenta, cyan, and yellow reference boards 56M1, 56C1, and 56Y1) and a second reference board (e.g., magenta, cyan, and yellow reference boards 56M2, 56C2, and 56Y2). The first reference board has a spectral reflectance distribution corresponding to a spectral reflectance distribution of a surface of the first image. The second reference board has a spectral reflectance distribution corresponding to a spectral reflectance distribution of a surface of the second image.

Accordingly, as described above with respect to the variation of the test toner image Ta and the reference board 56, an accurate image density (e.g., amount of toner contained in the image) is detected.

A description is now given of advantages in an aspect O of the present disclosure.

A method for detecting image density includes: emitting light to an image (e.g., test toner image Ta) on a surface of an image bearer (e.g., intermediate transfer belt 31); detecting image density of the image (e.g., amount of toner contained in the image) based on the light emitted to and reflected from the image; emitting light to a reference board (e.g., reference board 56) having a predetermined spectral reflectance distribution; and correcting a detecting condition of the image density or an image density detecting condition (e.g., toner pattern output used for detecting image density) based on the light emitted to and reflected from the reference board. The predetermined spectral reflectance distribution of the reference board is closer to a spectral reflectance distribution of an image forming material (e.g., toner) with which the image is formed than a spectral reflectance distribution of white.

Accordingly, the image density detecting condition is corrected as appropriate to detect an accurate image density, compared to a comparative method for detecting image density that uses a white reference board.

A description is now given of advantages in an aspect P of the present disclosure.

In the aspect O, the light is emitted to the reference board (e.g., reference board 56) in response to detection of a predetermined or larger change in an environmental condition (e.g., temperature). The image density detecting condition (e.g., condition for detecting an amount of toner contained in the image) is corrected based on the light emitted to and reflected from the reference board.

Accordingly, the image density detecting condition after the environmental change is corrected based on the light reflected from the reference board after the temperature change. Therefore, even when the light-emitting characteristics of the light emitter or the light-receiving characteristics of the light receiver change due to the environmental change, the image density detecting condition is corrected as appropriate to detect an accurate image density.

If the environmental condition changes less than the predetermined change, the light is not emitted to the reference board to reduce a burden on the controller.

A description is now given of advantages in an aspect Q of the present disclosure.

A method for forming an image (e.g., toner image) on a recording medium includes: forming a first image for density detection (e.g., test toner image Ta) on a surface of an image bearer (e.g., intermediate transfer belt 31); detecting image density of the first image (e.g., amount of toner contained in the test toner image Ta) according to the method of the aspect O or P described above; adjusting one or more image forming conditions based on the image density thus detected; and forming a second image under the one or more image forming conditions thus adjusted.

Accordingly, an accurate image density is detected. One or more image forming conditions are adjusted based on the image density thus detected. As a consequence, an image without unevenness in density is output.

The present disclosure has been described above with reference to specific embodiments. It is to be noted that the present disclosure is not limited to the details of the embodiments described above, but various modifications and enhancements are possible without departing from the scope of the present disclosure. It is therefore to be understood that the present disclosure may be practiced otherwise than as specifically described herein. For example, elements and/or features of different embodiments may be combined with each other and/or substituted for each other within the scope of the present disclosure. The number of constituent elements and their locations, shapes, and so forth are not limited to any of the structure for performing the methodology illustrated in the drawings.

Any one of the above-described operations may be performed in various other ways, for example, in an order different from the one described above.

Further, any of the above-described devices or units can be implemented as a hardware apparatus, such as a special-purpose circuit or device, or as a hardware/software combination, such as a processor executing a software program.

Further, as described above, any one of the above-described and other methods of the present disclosure may be embodied in the form of a computer program stored in any kind of storage medium. Examples of storage mediums include, but are not limited to, flexible disk, hard disk, optical discs, magneto-optical discs, magnetic tapes, nonvolatile memory cards, read only memory (ROM), etc.

Alternatively, any one of the above-described and other methods of the present disclosure may be implemented by an application specific integrated circuit (ASIC), prepared by interconnecting an appropriate network of conventional component circuits or by a combination thereof with one or more conventional general purpose microprocessors and/or signal processors programmed accordingly.

What is claimed is:

1. An image density detector for detecting image density of an image borne by an image bearer, the image density detector comprising:
a reference board having a spectral reflectance distribution closer to a spectral reflectance distribution of the image forming material than a spectral reflectance distribution of white;
a light emitter to emit light to the reference board and the image borne by the image bearer; and
a light receiver to receive the light emitted by the light emitter and reflected from the image and the reference board;
an image density calculator to calculate the image density of the image based on an output of the light receiver receiving the light emitted by the light emitter and reflected from the image; and
an image density detecting condition corrector to correct an image density detecting condition based on an output of the light receiver receiving the light emitted by the light emitter and reflected from the reference board.

2. The image density detector according to claim 1, wherein the reference board includes a plurality of reference boards differing from each other in spectral reflectance distribution, and
wherein the plurality of reference boards is selectively used to correct the image density detecting condition depending on the spectral reflectance distribution of the image forming material.

3. The image density detector according to claim 1, further comprising an environmental condition detector to detect an environmental condition under which the image density detector operates,
wherein, in response to a predetermined or larger change in the environmental condition detected by the environmental condition detector, the light emitter emits light to the reference board and the light receiver receives the light emitted by the light emitter and reflected from the reference board.

4. The image density detector according to claim 3, wherein the light emitter includes a plurality of light emitting devices, and
wherein a reflectance of the image forming material becomes 90% or less of a maximum reflectance of the image forming material in the spectral reflectance distribution of the image forming material in a spectrum around a peak of a spectral distribution of light emitted by at least one of the plurality of light emitting devices.

5. The image density detector according to claim 3, wherein the light emitter includes a plurality of light emitting devices, and
wherein the environmental condition detector is a temperature detector and the predetermined change in the environmental condition detected by the temperature detector is a temperature change determined by temperature characteristics of the plurality of emitting devices.

6. The image density detector according to claim 3, wherein the reference board includes a plurality of reference boards differing from each other in spectral reflectance distribution, and
wherein a plurality of degrees of the predetermined change in the environmental condition triggers detection of the plurality of reference boards, respectively.

7. The image density detector according to claim 6, wherein the plurality of reference boards have the spectral reflectance distributions corresponding to spectral reflectance distributions of cyan, yellow, and magenta image forming materials, respectively, and
wherein the degree of the predetermined change in the environmental condition for detecting one of the plurality of reference boards having the spectral reflectance distribution corresponding to the spectral reflectance distribution of the magenta image forming material is smaller than the degrees of the predetermined change in the environmental condition for detecting rest of the plurality of reference boards.

8. The image density detector according to claim 1, further comprising a black board having a black surface,
wherein the light emitter emits light to the black board.

9. The image density detector according to claim 8, further comprising:
a foreign matter identifier to determine whether foreign matter is present between the black board and the light emitter or between the black board and the light receiver, based on an output of the light receiver receiving the light emitted to the black board; and
a process executer to execute one of a process of not using a partial output of the light receiver receiving light reflected from the foreign matter and a process of removing the foreign matter, in response to determination by the foreign matter identifier that the foreign matter is present.

10. The image density detector according to claim 1, wherein the image bearer rotates relatively to the light receiver,
wherein the light receiver includes a plurality of light receiving devices aligned across a width direction of the image bearer, in a direction perpendicular to a direction of rotation of the image bearer, and
wherein the reference board has an even spectral reflectance distribution throughout an entire area in which the light receiver receives reflection light in the width direction of the image bearer.

11. An image forming apparatus comprising:
an image bearer;
an image forming device to form an image with an image forming material on a surface of the image bearer;
the image density detector according to claim 1 to detect image density of the image formed on the surface of the image bearer; and
an image forming condition adjuster to adjust one or more image forming conditions of the image forming device based on the image density detected by the image density detector.

12. The image forming apparatus according to claim 11, wherein the image forming device includes:
a cyan image forming device to form a cyan image with a cyan image forming material;
a yellow image forming device to form a yellow image with a yellow image forming material; and
a magenta image forming device to form a magenta image with a magenta image forming material, and
wherein the reference board includes a plurality of reference boards having spectral reflectance distributions corresponding to spectral reflectance distributions of the cyan, yellow, and magenta image forming materials, respectively.

13. The image forming apparatus according to claim 12, wherein, in the spectral reflectance distribution of the cyan image forming material in a spectrum of from 400 nm to 700 nm, a reflectance of the cyan image forming material becomes 70% of a difference between a maximum reflectance of the cyan image forming material and a minimum reflectance of the cyan image forming material in spectra of 420±20 nm and 510±20 nm,
wherein, in the spectral reflectance distribution of the magenta image forming material in the spectrum of from 400 nm to 700 nm, a reflectance of the magenta image forming material becomes 70% of a difference between a maximum reflectance of the magenta image forming material and a minimum reflectance of the magenta image forming material in a spectrum of 610±20 nm, and
wherein, in the spectral reflectance distribution of the yellow image forming material in the spectrum of from 400 nm to 700 nm, a reflectance of the yellow image forming material becomes 70% of a difference between a maximum reflectance of the yellow image forming material and a minimum reflectance of the yellow image forming material in a spectrum of 510±20 nm.

14. The image forming apparatus according to claim 11, wherein the image formed by the image forming device includes:
a first image having a predetermined image area rate; and
a second image having an image area rate lower than the predetermined image area rate of the first image, and
wherein the reference board includes:
a first reference board having a spectral reflectance distribution corresponding to a spectral reflectance distribution of a surface of the first image; and
a second reference board having a spectral reflectance distribution corresponding to a spectral reflectance distribution of a surface of the second image.

15. A method for detecting image density, the method comprising:
emitting light to an image on a surface of an image bearer;
detecting image density of the image based on the light emitted to and reflected from the image;
emitting light to a reference board having a predetermined spectral reflectance distribution closer to a spectral reflectance distribution of an image forming material with which the image is formed than a spectral reflectance distribution of white; and
correcting an image density detecting condition based on the light emitted to and reflected from the reference board.

16. The method according to claim 15, wherein the light is emitted to the reference board in response to detection of a predetermined or larger change in an environmental condition, and
wherein the image density detecting condition is corrected based on the light emitted to and reflected from the reference board.

17. A method for forming an image on a recording medium, the method comprising:
forming a first image for density detection on a surface of an image bearer;
detecting image density of the first image according to the method of claim 15;
adjusting one or more image forming conditions based on the image density thus detected; and
forming a second image under the one or more image forming conditions thus adjusted.
